(19) United States
(12) Patent Application Publication
(10) Pub. No.: US 2026/0003924 A1
(43) Pub. Date: Jan. 1, 2026

(54) INFORMATION CONTENT PROCESSING METHOD, COMPUTER DEVICE, AND STORAGE MEDIUM

(71) Applicant: TENCENT TECHNOLOGY (SHENZHEN) COMPANY LIMITED, Shenzhen (CN)

(72) Inventors: Ruijie JIANG, Shenzhen (CN); Chuchongtian WANG, Shenzhen (CN); Xiang WANG, Shenzhen (CN); Jianru ZHU, Shenzhen (CN)

(21) Appl. No.: 19/257,145

(22) Filed: Jul. 1, 2025

Related U.S. Application Data
(63) Continuation of application No. PCT/CN2024/089794, filed on Apr. 25, 2024.

(30) Foreign Application Priority Data
Jun. 15, 2023 (CN) 202310714614.5

(51) Int. Cl. G06F 16/9538; G06F 3/04883; G06F 16/34; G06F 16/9535; G06Q 50/00; H04L 51/02; H04L 51/52

(52) U.S. Cl. CPC G06F 16/9538; G06F 3/04883; G06F 16/345; G06F 16/9535; G06Q 50/01; H04L 51/02; H04L 51/52

(57) ABSTRACT

An information content processing method performed by a terminal device with a social client logged in with a first account running thereon includes obtaining recommendation information content recommended by an artificial intelligence (AI) assistant for the first account, the recommendation information content being obtained after the AI assistant filters or summarizes information content of the first account in at least one service function of the social client; and displaying the recommendation information content.

### CROSS-REFERENCES TO RELATED APPLICATIONS

This application is a continuation application of PCT Patent Application No. PCT/CN2024/089794, filed on Apr. 25, 2024, which claims priority to Chinese Patent Application No. 202310714614.5, filed on Jun. 15, 2023, all of which is incorporated herein by reference in their entirety.

### FIELD OF THE TECHNOLOGY

The present disclosure relates to the field of artificial intelligence (AI), and in particular, to an information content processing method and apparatus, a device, and a storage medium.

### BACKGROUND OF THE DISCLOSURE

With continuous development of technologies such as hardware, computing power, network transmission, and algorithms, more and more information is being generated and transmitted. Connections between people are no longer limited by geographic location, but may continuously extend in virtual network spaces, with social accessibility becoming increasingly enhanced. However, at the same time, the excessive amount of information has led to issues such as delays in processing information and overly dispersed attention.

In related technologies, when using a social client, a user needs to switch between different contacts/group chat interfaces/dynamics message spaces to read/reply to social messages, as well as switch between different levels of business/service function interfaces to use different functions.

However, the continuous increasing of information content on the social client has become a burden for users. As a result, how to improve processing efficiency of information content is a problem that needs to be resolved.

### SUMMARY

One embodiment of the present disclosure provides an information content processing method, performed by a terminal device with a social client logged in with a first account running thereon. The social client includes at least one service function. The method includes obtaining recommendation information content recommended by an artificial intelligence (AI) assistant for the first account, the recommendation information content being obtained after the AI assistant filters or summarizes information content of the first account in the at least one service function; and displaying the recommendation information content.

Another embodiment of the present disclosure provides a computer device, having a social client logged in with a first account running thereon. The computer device includes one or more processors and a memory containing at least one program that, when being executed, causes the one or more processors to perform: obtaining recommendation information content recommended by an artificial intelligence (AI) assistant for the first account, the recommendation information content being obtained after the AI assistant filters or summarizes information content of the first account in at least one service function of the social client; and displaying the recommendation information content.

Another embodiment of the present disclosure provides a non-transitory computer-readable storage medium containing at least one program that, when being executed, causes at least one processor of a computer device that has a social client logged in with a first account running thereon to perform: obtaining recommendation information content recommended by an artificial intelligence (AI) assistant for the first account, the recommendation information content being obtained after the AI assistant filters or summarizes information content of the first account in at least one service function of the social client; and displaying the recommendation information content.

### BRIEF DESCRIPTION OF THE DRAWINGS

FIG. 1 is a schematic diagram of an interface of an information content processing method according to an exemplary embodiment of the present disclosure.

FIG. 2 is a schematic diagram of an interface of an information content processing method according to an exemplary embodiment of the present disclosure.

FIG. 3 is a schematic diagram of an interface of an information content processing method according to an exemplary embodiment of the present disclosure.

FIG. 4 is a schematic diagram of an interface of an information content processing method according to an exemplary embodiment of the present disclosure.

FIG. 5 is a structural block diagram of a computer system according to an exemplary embodiment of the present disclosure.

FIG. 6 is a flowchart of an information content processing method according to an exemplary embodiment of the present disclosure.

FIG. 7 is a flowchart of an information content processing method according to an exemplary embodiment of the present disclosure.

FIG. 8 is a flowchart of data processing of an information content processing method according to an exemplary embodiment of the present disclosure.

FIG. 9 is a timing diagram of an information content processing method according to an exemplary embodiment of the present disclosure.

FIG. 10 is a flowchart of an information content processing method according to an exemplary embodiment of the present disclosure.

FIG. 11 is a structural block diagram of an information content processing apparatus according to an exemplary embodiment of the present disclosure.

FIG. 12 is a structural block diagram of an information content processing apparatus according to an exemplary embodiment of the present disclosure.

FIG. 13 is a block diagram of a computer device according to an exemplary embodiment of the present disclosure.

### DESCRIPTION OF EMBODIMENTS

To make the objectives, technical solutions, and advantages of the present disclosure clearer, the following describes implementations of the present disclosure in further detail with reference to accompanying drawings.

First, terms that may occur in the present disclosure are explained.

Chat Generative Pre-trained Transformer (ChatGPT): It is an AI chat robot program developed by OpenAI, and is launched in November 2022. The program uses a large language model based on GPT-3.5 and GPT-4 architectures and is trained through reinforcement learning. Currently, ChatGPT still interacts in a text manner, and in addition to interacting in a natural human dialog manner, can be further configured for complex language jobs, including a plurality of tasks such as automatic text generation, automatic question-answering, and automatic summarization.

All In One (AIO, common chat window component): For example, in an instant messaging application, a user participates in many different types of sessions such as a friend session, a group session, and a public account session. To provide unified interactive experience for users, a chat window component shared by different sessions are provided in an application, and behavior habits such as input and click operations of users in the component may be considered to be consistent.

An information content processing method and apparatus, a device, and a storage medium relate to the field of artificial intelligence (AI) technologies. For example, the method includes: obtaining recommendation information content recommended by an artificial intelligence assistant for a first account, the recommendation information content being obtained after the AI assistant filters or summarizes information content of the first account in at least one service function of a social client; and displaying the recommendation information content. As disclosed, key content in a large amount of information content can be quickly obtained, thereby increasing information density, and improving information content processing efficiency.

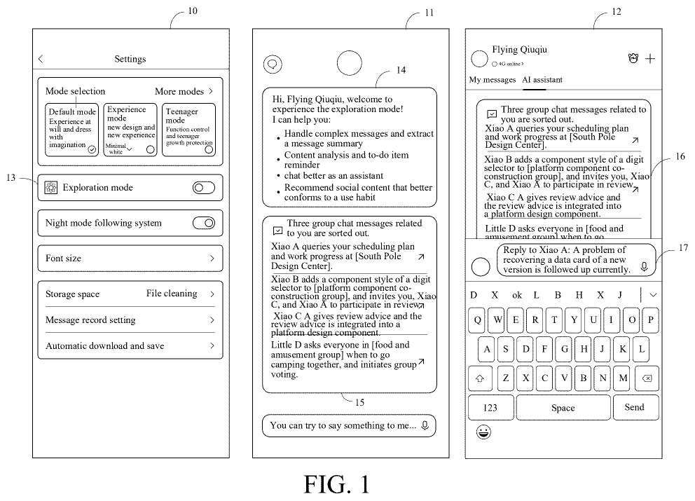

FIG. 1 to FIG. 4 are schematic diagrams of interfaces of an information content processing method according to an embodiment of the present disclosure.

As shown in FIG. 1, when a user uses a social client, a function portal 13 of an exploration mode (that is, a function of the AI assistant) is displayed on a mode switching interface 10 of the social client. The user may enable or disable a function of the AI assistant by performing a trigger operation on the function portal 13. After the user clicks the function portal 13 to enable a function of the AI assistant, a user interface (UI) jumps to a recommendation information content interface 11 that is displayed in a full screen. Recommendation information content 15 pushed by an AI assistant to a current user account is displayed on the recommendation information content interface 11. The recommendation information content 15 is displayed on the recommendation information content interface 11 in a form of a card.

The recommendation information content 15 is obtained by filtering or summarizing information content in a plurality of social functions by the AI assistant, that is, information content that the user is most concerned about and that is extracted by using an analysis processing capability of an AI language model. For example, the recommendation information content 15 is unread messages of the current user account within a particular time, and includes a summary of unread messages in a private chat and a group chat. For another example, the recommendation information content 15 is a summary of friend dynamics that the current user account may be concerned about, such as a friend birthday reminder and a friend dynamics update. For another example, the recommendation information content 15 is a recommendation for a social relationship network interaction that the current user account may be concerned about, such as a friend whom the user may know, a good friend whom the user recently contacts most frequently, or an old friend whom the user once contacted but has not contacted recently. For another example, the recommendation information content 15 is a recommendation for social content related to an interest tag that the current user account may be concerned about, such as a short video, an interest group, or a game. In some embodiments, an introduction guide 14 of the AI assistant is further displayed on the recommendation information content interface 11.

An example in which the recommendation information content 15 is a summary of unread messages is used. After obtaining the recommendation information content 15 on the recommendation information content interface 11, the current user account may jump to a conventional chat message list to view all messages, and then reply; or may make a quick reply to corresponding messages by using a natural language in a manner of a shortcut instruction. For example, a summary 16 of group chat messages related to the current user account is displayed on an AI assistant interface 12. The current user account may directly input, by using a natural language in a dialog box of the AI assistant interface 12, an object and content 17 that the user intends to reply to, for example, “Reply to Xiao A: A problem of recovering a data card of a new version is followed up currently”, so as to make a quick reply to the messages. In some embodiments, the quick reply based on a natural language supports text interaction and/or voice interaction, and the user may freely select the text interaction and/or voice interaction.

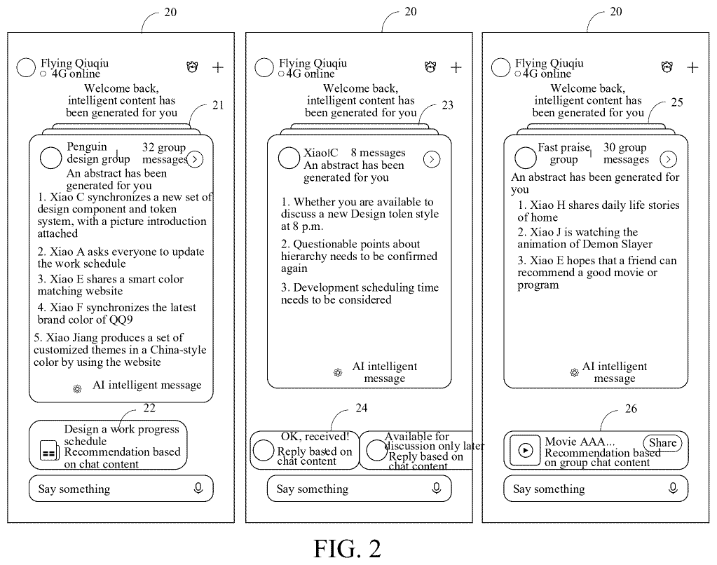

The recommendation information content 15 is displayed on the UI in a form of a card. Display of the card in a tiled or stacked manner is supported. FIG. 1 is a schematic diagram of an interface of displaying a plurality of cards in a tiled manner. FIG. 2 is a schematic diagram of an interface of displaying a plurality of cards in a stacked manner.

As shown in FIG. 2, when a current user account uses a social client, an AI assistant interface 20 is displayed on a UI, and recommendation information content is displayed on the AI assistant interface 20 in a stacked manner. The recommendation information content is, by default, an intelligent summary of group chat messages that are not read within a leaving time when the current user account does not use the social client, to improve information content processing efficiency of the user. The AI assistant further supports semantic understanding, and intelligently recommends, based on semantic understanding, a next task to be performed by the current user account, or recommends a function that is in the social client and that matches the recommendation information content. For example, recommendation information content 21 displayed on the AI assistant interface 20 includes a task “update a work schedule” posted in a group. After analyzing semantics, the AI assistant recommends a work schedule file related to the task to the current user account, and displays a work schedule file 22 related to the task on the AI assistant interface 20, so that the user can directly use the file to complete the task. For another example, recommendation information content 23 displayed on the AI assistant interface 20 includes a to-be-replied message related to work. After analyzing semantics, the AI assistant recommends reply content that is applicable to a work scenario and that matches the to-be-replied message to the current user account, and displays at least one type of quick reply content 24 on the AI assistant interface 20, so that the user can make a quick reply. For another example, recommendation information content 25 displayed on the AI assistant interface 20 includes a to-be-replied message related to entertainment. After analyzing semantics, the AI assistant recommends reply content to the current user account based on an interest tag of the current user account, and displays at least one piece of reply content 26 on the AI assistant interface 20, so that the user can make a quick reply or share.

In some embodiments, in addition to supporting processing of a text message shown in FIG. 2, the AI assistant also supports processing of a richer intelligent combination of rich media information (for example, a picture, a video, a 3D (three-dimensional) scenario, or a mini-game).

In some embodiments, similar to processing a text message, during processing of rich media information, the AI assistant may also match, based on a use habit of the current user account and a user tag, suitable recommended content or an associated function in or under a card of recommendation information content in a manner of a shortcut path portal, thereby further improving information processing efficiency of the user in the social client.

In some embodiments, a sorting sequence of cards of the recommendation information content may be a default sequence, a user-defining sequence, or a sequence optimized based on a use habit of the user. For example, the sequence of the cards of the displayed recommendation information content may be based on a default recommendation logic at an early stage. Subsequently, related search and recommendation logics are continuously strengthened with interaction between the user and the AI assistant and gradually abundant user tags, so that the sorting sequence of the cards of the recommendation information content better conforms to habits of the user, and the recommendation information content better meets interests of the user. In this way, the AI assistant and the user can process information and associated tasks in the social client efficiently and cooperatively, thereby improving information processing efficiency of the user.

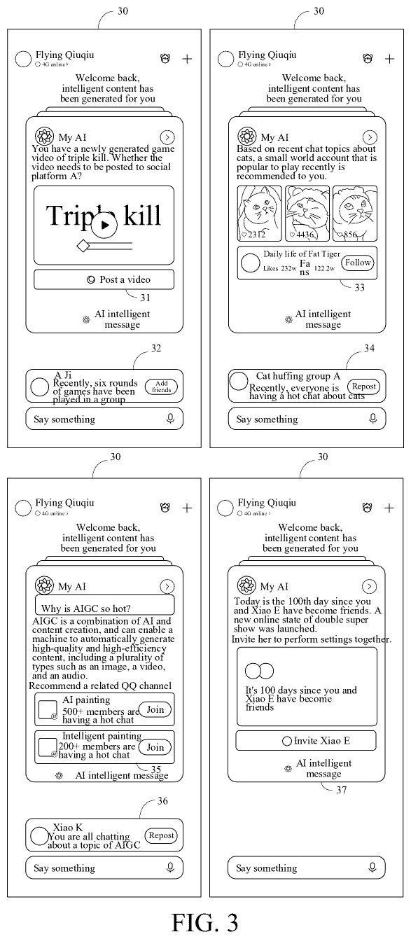

In some embodiments, in addition to being associated content or an associated function in the social client, the recommendation information content may be associated content or an associated function from a third party, to adapt to a social requirement of the user more intelligently. For example, the recommendation information content includes takeout software, taxi hailing software, or third-party short/long video software. FIG. 3 is a schematic diagram of an interface on which recommendation information content includes associated content or an associated function from a third party. For example, based on a recent game activity of a current user account, a game video 31 that the current user account is recommended to post to a third-party platform, and another user 32 involved in a game activity recommended to the current user account are displayed on an AI assistant interface 30. For another example, if an interest tag of a current user account is cat, a user account 33 that is related to cat, that the current user account is recommended to follow, and that is from a third-party platform, and a group chat 34 that is recommended to the current user account are displayed on an AI assistant interface 30. For another example, if an interest tag of a current user account is AI content creation, a channel 35 that is related to AI content creation, that the current user account is recommended to follow, and that is from a third-party platform, and a user account 36 that has the same interest tag and that is recommended to the current user account are displayed on an AI assistant interface 30. For another example, based on a social relationship of a current user account in a social client, a link 37 of a third-party platform that the current user account is recommended to share with a friend of the current user account is displayed on an AI assistant interface 30.

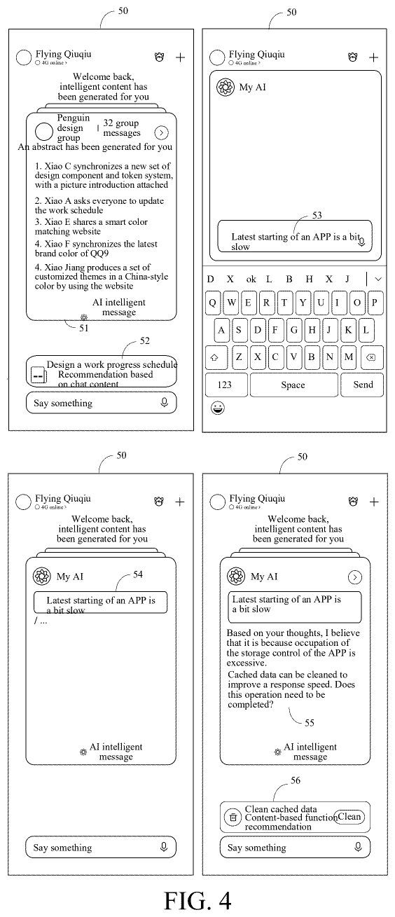

In some embodiments, the current user account not only can view a card of the recommendation information content generated by the AI assistant, but also can interact with the AI assistant to obtain the information content. As shown in FIG. 4, recommendation information content including a group chat information summary 51 and a related file 52 is displayed on an AI assistant interface 50. The user may interact with the AI assistant through text input or voice input in an input box region 53 at the bottom of the AI assistant interface 50. For example, “Latest starting of an APP is a bit slow” is input in the input box region 53. After the message is sent, the message is displayed on a card 54 interacting with the AI assistant. The AI assistant performs semantic analysis on the message, and displays reply content 55 and recommendation-related content 56 on the AI assistant interface 50.

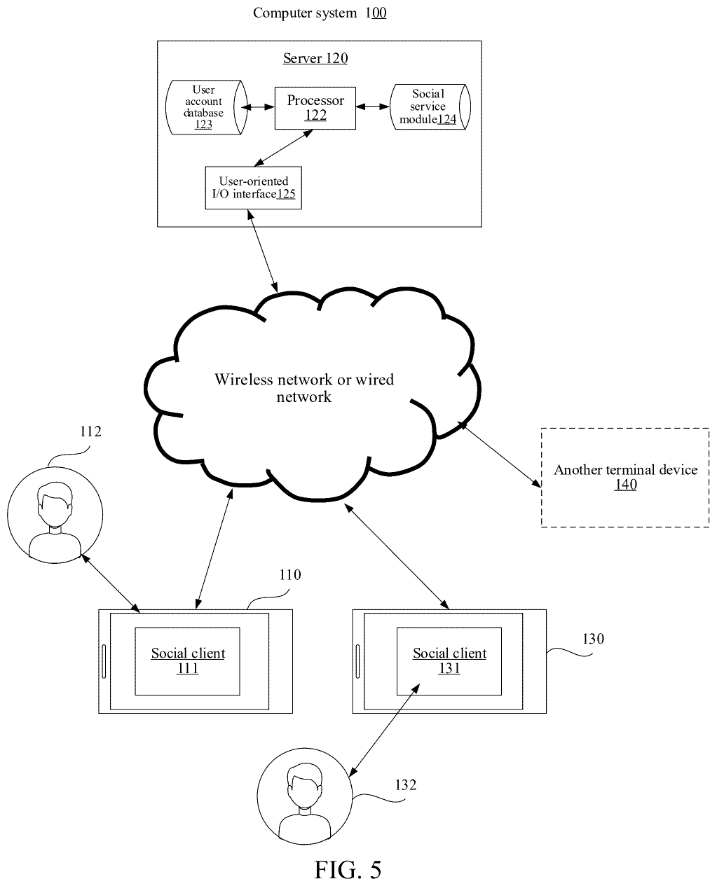

FIG. 5 is a structural block diagram of a computer system according to an exemplary embodiment of the present disclosure. The computer system 100 includes a first terminal device 110, a server 120, and a second terminal device 130.

A first client 111 supporting a social function is installed and run on the first terminal device 110. The first client 111 may be an application or a web page client having a social function. When the first terminal device 110 runs the first client 111, a UI of the first client 111 is displayed on a screen of the first terminal device 110. The application may be any one of an instant messaging program, a microblog program, a network community program, a payment program, a shopping program, a friend-making program, and a love and marriage program. In this embodiment, an example in which the application is an instant messaging program is configured for description. The first terminal device 110 is a terminal device used by a first user 112, and a first account of the first user 112 is logged onto the first client 111.

A second client 131 supporting a social function is installed and run on the second terminal device 130. The second client 131 may be an application or a web page client having a social function. When the second terminal device 130 runs the second client 131, a UI of the second client 131 is displayed on a screen of the second terminal device 130. The application may be any one of an instant messaging program, a microblog program, a network community program, a payment program, a shopping program, a friend-making program, and a love and marriage program. In this embodiment, an example in which the application is an instant messaging program is configured for description. The second terminal device 130 is a terminal device used by a second user 132, and a second user account of the second user 132 is logged onto the second client 131.

In some embodiments, applications installed in the first terminal device 110 and the second terminal device 130 may be the same, or applications installed in the two terminal devices are applications of the same type on different operating system platforms (that is, Android or iOS). The first terminal device 110 may generally refer to one of a plurality of terminal devices, and the second terminal device 130 may generally refer to another one of the plurality of terminal devices. In this embodiment, the first terminal device 110 and the second terminal device 130 are merely used as an example for description. Device types of the first terminal device 110 and the second terminal device 130 are the same or different. The device type includes: at least one of a smart phone, a tablet computer, an e-book reader, an MP3 player, an MP4 player, a laptop portable computer, and a desktop computer.

FIG. 5 only shows two terminal devices. However, in different embodiments, there may be a plurality of other terminal devices 140 that can access the server 120. In some embodiments, one or more terminal devices 140 are terminal devices corresponding to a developer. By installing, in the terminal device 140, a developing and editing platform for a client that supports a social function, the developer can edit and update the client in the terminal device 140, and transmit an updated application installation package to the server 120 through a wired or wireless network. The first terminal device 110 and the second terminal device 130 may download the application installation package from the server 120 to update the client.

The first terminal device 110, the second terminal device 130, and the other terminal devices 140 are connected to the server 120 through the wired or wireless network.

The server 120 includes at least one of one server, a plurality of servers, a cloud computing platform, and a virtualization center. The server 120 is configured to provide a back-end service for the client that supports the social function. In some embodiments, the server 120 undertakes main computing work and the terminal device undertakes secondary computing work; or the server 120 undertakes secondary computing work and the terminal device undertakes main computing work; or a distributed computing architecture is used between the server 120 and the terminal device to perform collaborative computing.

In some embodiments, the server 120 includes a processor 122, a user account database 123, a social service module 124, and a user-oriented input/output interface (I/O interface) 125. The processor 122 is configured to load instructions stored in the server 120, and process data in the user account database 123 and the social service module 124. The user account database 123 is configured to store data of user accounts used by the first terminal device 110, the second terminal device 130, and the other terminal devices 140, for example, avatars of the user accounts, nicknames of the user accounts, and groups of the user accounts. The social service module 124 is configured to provide a plurality of chat rooms (two-person chat or multi-person chat) for a user to chat, send an emoji, give a red envelope, and the like for instant messaging, or post and browse a social circle message. The user-oriented I/O interface 125 is configured to establish communication and exchange data with the first terminal device 110 and/or the second terminal device 130 through a wireless network or wired network.

With reference to the foregoing description of the implementation environment, the information content processing method provided in this embodiment of the present disclosure is described. An example in which the method is performed by a client running on a terminal device shown in FIG. 5 is configured for description. A client runs on the terminal device, the client is an application supporting a social function, an AI model is further set on the client, and the AI model is an AI model used by an AI assistant and is configured for obtaining recommendation information content based on information content on the client and supporting another AI service. Alternatively, the AI model used by the AI assistant may be set on the server in FIG. 5. The client sends the information content to the server, and then the server returns the recommendation information content generated by using the AI model to the client.

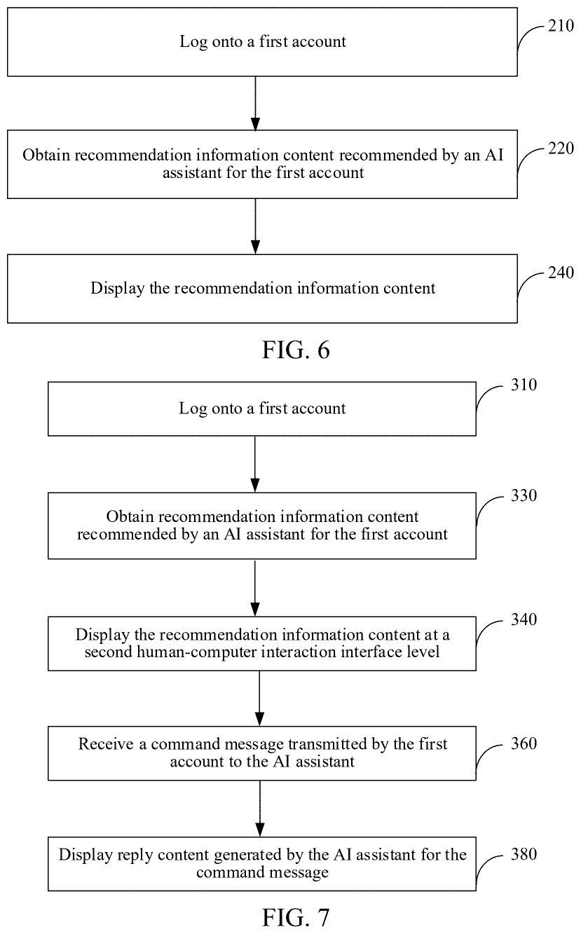

FIG. 6 is a flowchart of an information content processing method according to an exemplary embodiment of the present disclosure. This embodiment is described by using an example in which the method is performed by the terminal device or the client running on the terminal device shown in FIG. 5. For example, a social client onto which a first account is logged is run on the terminal device, and the social client includes at least one service function. The method includes at least one operation of operation 210 to operation 240 below.

In some embodiments, the following operation 210 may be implemented as a pre-performed operation. For example, after the first account is logged onto the social client of the terminal device, the terminal device may perform only the following operations 220 to 240.

Operation 210: Log onto a first account.

The first account is a user account that is currently logged onto the social client.

For example, a user logs onto the first account by clicking a login control after inputting a user name and a password on a login interface; or when a user sets automatic login, the first account is automatically logged onto when the user opens the social client.

Operation 220: Obtain recommendation information content recommended by an AI assistant for the first account.

The AI assistant refers to an AI service that is implemented based on at least an AI model and that is provided in the social client, to improve efficiency of processing information content by the user. Using an example in which an AI service is to process information content, the AI assistant is a recommendation service that filters or summarizes information content based on at least an AI model.

The AI model used by the AI assistant may be a language model, for example, a Large Language Model (LLM) or a Generative Language Model (GLM). The model is trained on a large amount of text data, aims to understand and generate a human language, and can perform various tasks such as text summarization, translation, and sentiment analysis. LLM refers to a language model in which model parameters exceed a first threshold, or training data exceeds a second threshold, or a calculation amount exceeds a third threshold, where the first threshold, the second threshold, and the third threshold are each a value at a level of hundred billions. In some embodiments, the AI model used by the AI assistant may alternatively be a model configured for text-to-picture conversion, picture-to-text conversion, text-to-video conversion, or the like. For example, the AI assistant uses a large language model, and provides AI services including summarizing unread social messages, optimizing a social network, backtracking historical social messages, question answering, function recommendation, emotional accompanying, and the like. This is not limited in the present disclosure.

The name of “AI assistant” may be displayed on a UI of the AI assistant. Alternatively, the name of “AI assistant” is not displayed, but content displayed on the interface is recommendation information content that is partially or completely generated by the AI model. Alternatively, the same type of function or the same type of name such as “intelligent service”, “AI manager”, or “exploration mode” is displayed. The recommendation information content recommended by the AI assistant for the first account may be completely generated by the AI model on which the AI assistant is based; or may be combined recommendation information content of recommendation information content generated by the AI model and that generated by using a suitable recommendation algorithm. The present disclosure does not limit the name of a function of the AI assistant, and does not completely limit all recommendation information content to being generated by the AI model used by the AI assistant.

The social client includes at least one service function. The service function is a function designed for social networking, and includes at least one of the following: a communication function (including a one-to-one private chat, a group chat, and the like), a contact function, a social circle function, and/or a short video function. The recommendation information content is obtained after the AI assistant filters or summarizes information content in at least one service function. The filtering means that extraction is performed from the information content in the at least one service function, that is, no secondary processing is performed. The summarizing means that a part of original information content is not directly selected, but general information content such as a summarization or a summary is formed through secondary processing.

Using an example in which the at least one service function is a communication function, the recommendation information content is content obtained after the AI assistant filters or summarizes information content in the communication function. For example, the recommendation information content is obtained by summarizing, by the AI assistant, key information content of unread social messages. For another example, the recommendation information content is obtained by filtering, by the AI assistant, historical social messages of a chat object specified by the first account. For another example, the recommendation information content is obtained by listing, by the AI assistant, to-do items of the first account in the communication function.

In some embodiments, the service function of the social client further includes a service function of a third-party application. The third-party application may be a third-party application inside the social client, or may be a third-party application outside the social client. The service function of the third-party application is a service function of the third-party application that the social client is authorized to use or synchronize, that is, the social client has a right to obtain information content in the service function of the authorized third-party application, and/or a right to call a performance function. For example, the social client obtains information content of a third-party application that is in the social client and that is configured for shopping. For another example, the social client calls a performance function of a third-party application that is outside the social client and that is configured for cleaning memory.

In some embodiments, the social client may include at least two service functions of different levels. The recommendation information content is obtained after the AI assistant filters or summarizes information content in the at least two service functions. For example, the recommendation information content includes a summary of information content of unread messages in the communication function, and filtering of friend dynamics in a social circle. For another example, the recommendation information content includes a summary of to-do items in the communication function, and recommendation of friends that may be known in the contact function.

For example, the social client includes a plurality of service functions, and at least two of the plurality of service functions are located at different human-computer interaction interface levels. Recommendation information content recommended by the AI assistant for a first account is obtained, the recommendation information content including information content obtained after the AI assistant filters or summarizes information content in a first service function, and the first service function being located at a first human-computer interaction interface level.

The human-computer interaction interface level is configured for indicating reachability of a human-computer interaction interface, that is, operation costs required for reaching the human-computer interaction interface, for example, operations required for going from a main interface of the social client to the human-computer interaction interface. A higher human-computer interaction interface level indicates fewer operations required for a user to reach the human-computer interaction interface.

For example, the recommendation information content is obtained after the AI assistant filters or summarizes information content in at least one service function. The recommendation information content includes at least one of the following:
first recommendation information content obtained after unread social messages of the first account are filtered or summarized, where for example, unread social messages in a chat list are filtered or summarized, to form the first recommendation information content, and the unread social messages may be unread social messages in a private chat, or unread social messages in a group chat, or unread social messages in a private chat/group chat specified by the first account, or unread social messages in a private chat/group chat whose quantity of unread social messages exceeds a number threshold;
second recommendation information content obtained after group chat messages of the first account or to-do items in a workflow are filtered or summarized, where for example, work arranged in a work group chat or information to which a reply needs to be made is selected, through filtering, as the second recommendation information content; for another example, a to-do item such as a group vote, a group file, or a group announcement is used as the second recommendation information content; for another example, a message that mentions the first account in a group chat or a message that mentions all members in a group chat is used as the second recommendation information content;
third recommendation information content obtained after candidate information is filtered or summarized according to a preset rule of the first account, where the user may self-define the recommendation information content; for example, the first account presets objects that need to be filtered or summarized by the AI assistant, and specifies a filtering or summarizing time range, a type of information content, and the like; for example, information content whose type is a document in the last year is filtered or summarized; for another example, dynamics messages of a dynamics space in the last month are filtered or summarized;
fourth recommendation information content obtained after friend dynamics information in a social network of the first account is filtered or summarized, where for example, the fourth recommendation information content is a dynamics update of a friend in a social circle; for another example, the fourth recommendation information content is a birthday reminder of a friend;
fifth recommendation information content randomly recommended for the first account, where for example, the fifth recommendation information content is hot news recommended by the first account; for another example, the fifth recommendation information content is information content that a friend of the first account is concerned about; or
fifth recommendation information content obtained after information content in which the first account has a potential interest is filtered or summarized, where for example, an interest tag of the first account is determined based on a topic that the first account is concerned about, and information content in which the first account may be interested is determined according to the interest tag, and is filtered or summarized and then recommended for the first account; for another example, a recommendation is made for the first account based on information content of the entire network platform on that day; for example, in a short video function, all hot short videos on that day are filtered or summarized;
sixth recommendation information content obtained after information content that has a sharing probability and that is of the first account is filtered or summarized, where for example, an interest tag of the first account or hot information that is concerned about is determined based on chat content between the first account and a friend of the first account, and information content related to the interest tag or the hot information that is concerned about is filtered or summarized and then recommended for the first account; for another example, the first account is supported in self-defining information content having a sharing probability, and is authorized to share the information content with a friend or a group chat;
seventh recommendation information content obtained after interest groups in which the first account has a potential interest are filtered or summarized, where for example, candidate interest groups in which the first account may be interested are determined based on the interest tag of the first account, and an interest group obtained by filtering or summarizing the candidate interest groups is recommended for the first account as the seventh recommendation information content;
eighth recommendation information content obtained after point of interest (POI) information corresponding to a current geographic location of the first account is filtered or summarized, where POI refers to point data on an Internet electronic map, and includes four attributes: a name, an address, a coordinate, and a category; for example, based on a current geographic location of the first account, merchant information, transportation services, and the like that are near the current geographic location and in which the first account may be interested are filtered or summarized, and are recommended for the first account as the eighth recommendation information content;
ninth recommendation information content obtained after strange accounts in which the first account has a potential interest are filtered or summarized, where for example, candidate accounts having interest tags the same as that of the first account are determined, the candidate accounts have a potential interest in the first account, and a candidate account obtained by filtering or summarizing the candidate accounts is recommended for the first account as the ninth recommendation information content;
tenth recommendation information content obtained after AI tools in which the first account has a potential interest are filtered or summarized, where the AI tool is a tool that is developed based on the AI technology and that is configured for solving a problem; for example, candidate AI tools in which the first account may be interested are determined based on the interest tag of the first account, and an AI tool obtained by filtering or summarizing the candidate tools is recommended for the first account as the tenth recommendation information content; for another example, if the interest tag of the first account is painting, an AI painting tool is recommended for the first account and a shortcut operation portal is provided;
eleventh recommendation information content obtained after games in which the first account has a potential interest are filtered or summarized, where for example, candidate games in which the first account may be interested are determined, and a game obtained by filtering or summarizing the candidate games is recommended for the first account as the eleventh recommendation information content; and/or
twelfth recommendation information content obtained after related information of third-party applications bound to the first account is filtered or summarized, where for example, preferential information obtained after preferential information of takeout software bound to the first account is filtered or summarized is recommended for the first account as the twelfth recommendation information content.

A type of information in the foregoing at least one service function may include at least one of the following types:
text information such as an SMS message, an x-blog, an x-message, or an email;
picture information such as a photograph, a painting, or an illustration;
video information such as a television program, a movie, or a short video;
audio information such as a song, a broadcast, or a radio station;
social network information such as a personal home page, a social circle, or a social platform;
game information such as an online game or a mobile game;
location information such as Global Positioning System (GPS) positioning or map navigation;
personal information such as personal basic data, interests and hobbies, personality traits, ability levels, or achievements;
group information such as a member composition of a group, a target task, an organization structure, a cultural atmosphere, or a behavior specification;
sentiment information such as an emotional state, attitude tendency, preference, or satisfaction evaluation of an individual or a group;
behavior information such as a behavior manner, a behavior result, or a behavior influence of an individual or a group; and/or
environment information such as a physical environment, a social environment, or a cultural environment in which an individual or a group is located.

Operation 240: Display the recommendation information content.

For example, the recommendation information content recommended by the AI assistant to the first account is displayed on an AI assistant interface.

For example, the social client includes a plurality of service functions, and at least two of the plurality of service functions are located at different human-computer interaction interface levels. After the recommendation information content obtained by performing filtering or summarizing by the AI assistant based on the information content in the first service function at the first human-computer interaction interface level is obtained, the recommendation information content recommended by the AI assistant to the first account is displayed at a second human-computer interaction interface level. The second human-computer interaction interface level is higher than the first human-computer interaction interface level. That is, fewer operations are required to reach the second human-computer interaction interface than the first human-computer interaction interface. That is, information content of the first human-computer interaction interface at a lower level is summarized or filtered, and then is displayed on the second human-computer interaction interface at a higher level, so that costs of obtaining the information content are lower, and efficiency is improved.

In some embodiments, at least two information cards are displayed at the second human-computer interaction interface level, each of the at least two information cards being configured for displaying one piece or one group of recommendation information content recommended by the AI assistant to the first account. A group of recommendation information content is derived from the same service function; or is derived from the same group chat/contact; or belongs to the same topic. For example, an information summary of unread social messages of a group chat/contact is displayed on each information card. For another example, a filtering result of key information in a service function is displayed on each information card. The area of the information card is less than or equal to the area of the UI, and the information card is displayed at an upper layer of the UI. Displaying the recommendation information content in a form of an information card can distribute different pieces of recommendation information content on different information cards, thereby enriching display forms of the recommendation information content, and improving display flexibility of the recommendation information content.

The information card includes at least one piece of the following information:
account information of a second account (for example, an avatar of the second account, a nickname of the second account, or a remark name of the first account for the second account);
a quantity of related messages (for example, a quantity of unread messages sent by the second account to the first account);
whether to be filtered or summarized information content (for example, “Already generate a summarization for you” is displayed);
at least one message obtained through filtering (for example, an important message obtained by filtering unread messages);
at least one message obtained through summarization (for example, a message obtained by summarizing unread messages); and/or
whether to be an identifier of information content processed by the AI model (for example, “AI intelligent message” is displayed).

The at least two information cards may be displayed in a tiled form, or may be displayed in a stacked form. That is, the at least two information cards are tiled and displayed from top to bottom in a non-overlapping manner (a plurality of information cards may be simultaneously displayed on the UI, as shown in FIG. 1), and the user may view different information cards through an up-and-down sliding operation; or the at least two information cards are stacked and displayed in a manner of partial or complete overlapping (only one information card is displayed on the UI, as shown in FIG. 2), and the user may switch different information cards through a sliding operation.

In some embodiments, the at least two information cards are displayed in a tiled manner at the second human-computer interaction interface level, a tiling sequence of the at least two information cards being determined based on recommendation priorities of the at least two information cards.

In some other embodiments, the at least two information cards are displayed in a stacked manner at the second human-computer interaction interface level, a stacking sequence of the at least two information cards being determined based on recommendation priorities of the at least two information cards.

The recommendation priority may be a default priority of the social client; or may be a user-defined priority; or a priority that is obtained through optimization in a machine learning manner based on a manner in which the user uses the social client. For example, an interest tag library is constructed for each user account, and interest tags in the interest tag library are derived from a use process of the user account in the social client; and a weight of each interest tag is adjusted based on factors such as a use frequency and an interaction frequency of the user account. When determining the recommendation information content of the first account, the AI assistant filters or summarizes the recommendation information content based on interest tags of the first account, and sorts different pieces of recommendation information content based on weights of the interest tags as priorities.

In a stacked display manner, the user needs to switch and display different information cards, and the different information cards may be switched by performing a sliding operation. That is, in response to a sliding operation on a first information card of the at least two information cards, display of the first information card is canceled, and a second information card is displayed, the second information card being an information card ranked behind the first information card according to the stacking sequence. Alternatively, in response to an upward sliding operation on a first information card of the at least two information cards, display of the first information card is canceled, and a second information card is displayed; and/or in response to a downward sliding operation on a second information card of the at least two information cards, display of the second information card is canceled, and a first information card is displayed. the second information card being an information card ranked behind the first information card according to the stacking sequence.

In some embodiments, in response to different slide directions on a first information card of the at least two information cards, different second information cards are displayed. For example, upward/downward slide is displaying a former card/latter card of a card of the same type (the same service function), and left/right slide is displaying a former card/latter card of a card of a different type.

In some embodiments, a display level of the recommendation information content recommended by the AI assistant to the first account is higher than a level of a corresponding original function of the recommendation information content. For example, an original function level is the third level, and the display interface of the AI assistant is at the first level, to ensure that the user can reach important information more timely. An example in which the recommendation information content is a summary of unread social messages is used. When the social client is opened, the recommendation information content on the AI assistant interface is displayed, and original unread social messages can be displayed only after successively jumping to a main interface, a contact interface, and a chat interface. Therefore, the AI assistant may enable important information content to be reached by the user earlier.

In some embodiments, the first account first enables the AI assistant, and then displays, on the UI, the recommendation information content recommended by the AI assistant to the first account. That is, before a jump to an interface of a function of the AI assistant is made, a function portal for entering a function of the AI assistant is set.

For example, a function portal of a function of the AI assistant is displayed; and in response to a trigger operation on the function portal, the recommendation information content recommended by the AI assistant to the first account is displayed. For example, the function portal 13 of the function “exploration mode” of the AI assistant is displayed on the mode switching interface 10 in FIG. 1; and after the user enables the function of the AI assistant through the trigger operation on the function portal 13, the recommendation information content recommended by the AI assistant to the first account, for example, the recommendation information content 15 displayed on the recommendation information content interface 11 is displayed. The portal of the function of the AI assistant may be displayed on a main interface of opening the social client, or may be displayed on a service function setting interface, or may be displayed on a group chat/contact setting interface, or the like. This is not limited in the present disclosure.

In the technical solution provided in this embodiment of the present disclosure, recommendation information content is displayed in response to a trigger operation on a function portal, to satisfy different user requirements. When the user does not intend to enable the function of the recommendation information content, the function portal may not be triggered, and when the user intends to enable the function of the recommendation information content, the function portal may be triggered, that is, flexible setting of the AI assistant is implemented.

In some embodiments, when the first account enables the AI assistant, the AI assistant may be enabled for all service functions, or the AI assistant may be enabled for a service function specified by the first account; and for a service function for which the AI assistant is enabled, the first account may specify some ranges in which the AI assistant is enabled. That is, a range granularity that is specified by the first account and in which the AI assistant is enabled may be a social function granularity, a group chat granularity, a contact granularity, or the like. For example, the first account may specify that the function of the AI assistant is enabled for a work group whose information needs to be quickly mastered and a group chat with a relatively large quantity of messages.

In some embodiments, in the process of displaying the recommendation information content, or before or after displaying the recommendation information content, a shortcut operation portal associated with the recommendation information content is displayed; and in response to an operation on the shortcut operation portal, a shortcut processing function corresponding to the shortcut operation portal is executed.

While the recommendation information content recommended by the AI assistant to the first account is displayed on the UI of the first account, a shortcut operation portal associated with the recommendation information content is displayed, where a type of the shortcut operation portal and an operation performed by the user on the shortcut operation portal include at least one of the following:
The shortcut operation portal is a jump portal configured for jumping to a function UI of a function to which the recommendation information content belongs:

In response to a first operation on the shortcut operation portal, a function UI of a function to which the recommendation information content belongs is displayed, the function UI including original information content corresponding to the recommendation information content. For example, if the recommendation information content is a summary of unread social messages derived from an account A, the shortcut operation portal may be clicked to jump to a chat dialog interface between the first account and the account A, to view complete chat content.
The shortcut operation portal is a reply portal configured for replying to the second account:

When the recommendation information content is derived from a social message of the second account, reply content with which the first account replies to the recommendation information content is obtained in response to a second operation on the shortcut operation portal; and a reply message is sent to the second account, the reply message carrying the reply content. For example, the recommendation information content is a summary of social messages derived from the second account. The first account may directly input reply content for the social message at the shortcut operation portal on an interface (that is, the AI assistant interface) on which the recommendation information content is displayed, and a reply message carrying the reply content is sent to the second account. As shown in FIG. 1, a summary of group chat messages related to the first account is displayed in an information card. Each group chat message includes a group chat name, a name of a group member that mentions the first account, and message content that mentions the first account; and a dialog box for inputting is displayed below the information card, and the first account may reply to a group chat message in an information card summary by inputting a natural language in the dialog box. For example, the first account inputs the content 17 of the reply information to the dialog box, and the content is replied to the group chat member Xiao A. In this manner, the first account avoids a plurality of operations of first jumping to an original chat dialog interface with the second account and then replying to a message, but may directly reply to a message on the AI assistant interface, thereby quickly replying to a social message.

In some embodiments, the shortcut operation portal may be disposed inside the information card, for example, disposed below the recommendation information content or at the bottom of the information card; or the shortcut operation portal may be disposed at the bottom of the AI assistant interface, that is, below the information card; or the first account first clicks the recommendation information content to jump to an interface of original information content corresponding to the recommendation information content (that is, the first operation), and then inputs the reply information in a dialog box on the interface of the original information content.
The shortcut operation portal is a reply portal configured for replying to a third account by using quick reply content generated for the recommendation information content:

When the recommendation information content is derived from a social message of the third account, the quick reply content generated for the recommendation information content is displayed in a process of displaying the recommendation information content; and a reply message is sent to the third account in response to a third operation on the shortcut operation portal, the reply message carrying the quick reply content. For example, the recommendation information content is a social message derived from the third account. An example in which the recommendation information content is a summary of work tasks that the third account requires the first account to complete is used. While the recommendation information content is displayed, quick reply content, such as “Good, received”, “Arrive on time tomorrow”, or “Expected to complete before getting off work”, for the recommendation information content is displayed. For another example, as shown in FIG. 2, the recommendation information content 23 displayed on the information card on the AI assistant interface 20 includes a nickname or a remark name of a contact, a contact avatar, the quantity of unread messages from the contact, message content obtained through summarizing or filtering, an identifier indicating that a current message is the message content obtained through summarizing or filtering, and the like. The quick reply content 24 is further displayed at the bottom of the AI assistant interface 20. The quick reply content 24 may be one or more pieces of candidate quick reply content, and the plurality of pieces of candidate quick reply content are sequentially arranged left and right at the bottom of the AI assistant interface 20. The first account may select an appropriate reply message from the quick reply content by performing a left-right sliding operation, and send the reply message to the third account by performing a third operation. In this manner, the first account avoids manually inputting a reply message, but may directly select a reply message from recommended candidate reply messages, thereby making a quick reply to a social message.
The shortcut operation portal is a jump portal configured for jumping to an item processing interface of to-do items:

When the recommendation information content is derived from a social message of a fourth account and the social message is associated with a to-do item, a shortcut operation portal (that is, an access portal of to-do items) is displayed in a process of displaying the recommendation information content; and the item processing interface of to-do items is displayed in response to a fourth operation on the shortcut operation portal. The to-do items include at least one of an electronic document, a group vote, and a third-party application. For example, the recommendation information content is derived from the social message of the fourth account and is related to a to-do item. Using an example in which the to-do item is the group vote, when the recommendation information content is displayed, a jump portal of the group vote is displayed. The first account may jump to an item processing interface of the group vote by performing a trigger operation on the jump portal. For another example, as shown in FIG. 2, the recommendation information content 21 displayed on the information card on the AI assistant interface 20 includes a name or a remark name of a group chat, a group chat avatar, the quantity of unread messages from the group chat, message content obtained through summarizing or filtering, an identifier indicating that a current message is the message content obtained through summarizing or filtering, and the like. The social message from the group chat is associated with a to-do item. When the recommendation information content 21 is displayed, an electronic document 22 corresponding to the to-do item is displayed at the bottom of the AI assistant interface 20. The first account may open the electronic document 22 by performing a click operation on the electronic document 22 to directly complete the to-do item. In this manner, the first account may obtain content of a to-do item while obtaining a portal for rapidly processing the to-do item, thereby improving information content processing efficiency.
The shortcut operation portal is an access portal configured for accessing multimedia content:

When the recommendation information content is associated with multimedia content, the shortcut operation portal (that is, an access portal for multimedia content) is displayed in a process of displaying the recommendation information content; and in response to a fifth operation on of the shortcut operation portal, a multimedia content interface of the multimedia content is displayed. The multimedia content includes at least one of a picture, an audio, a video, and a game. For example, the recommendation information content is a recommendation for a game. While the recommendation information content is displayed, an access portal of the game is displayed. The first account may jump to a content interface of the game by performing a trigger operation on the access portal. In this manner, the first account may quickly jump to the multimedia content interface associated with the recommendation information content, thereby improving information content processing efficiency.
The shortcut operation portal is a sharing portal configured for sharing recommendation information content with a fifth account or a group:

In a process of displaying the recommendation information content, a shortcut operation portal for sharing the recommendation information content with a fifth account or a group is displayed, the fifth account or the group being recommended by the AI assistant in the social relationship chain of the first account; and the recommendation information content is shared with the fifth account or the group in response to a sixth operation on the shortcut operation portal. For example, the recommendation information content is a recommendation for a movie. While the recommendation information content is displayed, a sharing portal for sharing the movie with the fifth account or the group is displayed, and the first account may rapidly share the movie by performing a trigger operation on the sharing portal. As shown in FIG. 2, the recommendation information content 25 displayed on the information card on the AI assistant interface 20 includes a name or a remark name of a group chat, a group chat avatar, the quantity of unread messages from the group chat, message content obtained through summarizing or filtering, an identifier indicating that a current message is the message content obtained through summarizing or filtering, and the like. When the recommendation information content 25 is displayed, a sharing portal 26 configured for sharing the recommendation information content is displayed at the bottom of the AI assistant interface 20. The user may quickly share the recommendation information content with the fifth account or the group by performing a trigger operation on the sharing portal 26 (for example, a click operation on a sharing control). The fifth account or the group is an account or a group having a social relationship with the first account. For example, a user account that is of a friend of the first account and that has an interest tag the same as that of the first account is selected as the fifth account; or the first account self-defines the fifth account or the group with which the first account intends to share.
The shortcut operation portal is an addition portal of a sixth account or a group associated with the recommendation information content:

In a process of displaying the recommendation information content, an addition portal of a sixth account or a group associated with the recommendation information content is displayed; and the sixth account is added as a friend or the group is joined in response to a seventh operation on the shortcut operation portal. The sixth account or the group associated with the recommendation information content may be a sender of the recommendation information content, a participant of the recommendation information content, an account or a group chat mentioned in the recommendation information content, an account or a group chat that may be interested in the recommendation information content, an account or a group chat whose interest tag matches content included in the recommendation information content, or the like. As shown in FIG. 3, recommendation information content displayed on the AI assistant interface 30 is a game video 31 that a current user account is recommended to post to a third-party platform, an addition portal 32 of a sixth account that plays a game together with the first account is displayed, and a user may quickly add a friend of the sixth account by performing a trigger operation on the addition portal 32 (for example, a click operation on an addition control).

In some embodiments, the first account may further obtain a way to solve a problem by directly interacting with the AI assistant. That is, a command message transmitted by the first account to the AI assistant is received; and reply content generated by the AI assistant for the command message is displayed, the reply content being obtained after the AI assistant filters or summarizes, based on the command message, information content in the at least one social function. For example, the first account sends, to the AI assistant, a command message that summarizes information related to television dramas in a group chat A. After obtaining the information related to the television dramas in the group chat A and completely summarizing the information, the AI assistant displays reply content generated for the command message.

In some embodiments, the interest tag of the first account is obtained based on operation records of the first account on the social client or user information analysis. However, user information (including, but not limited to, personal information, social platform information, location information, social relationship information, and the like) and data (including, but not limited to, data for analysis, stored data, displayed data, and the like) involved in the present disclosure both are information and data that are authorized by a user or fully authorized by all parties. Collection, use, and processing of related data need to comply with relevant laws and regulations of relevant countries and regions. For example, the information such as the social platform information involved in the present disclosure is all obtained under full authorization. For another example, information such as information content involved in the present disclosure is authorized by a user and then obtained, and the user may self-define an authorized private chat/group chat and change settings at any time.

User information and data involved in the present disclosure undergoes sensitive information detection before being analyzed; and undergoes a desensitization operation and then is used and analyzed when sensitive information (for example, a sensitive keyword) is detected. In the present disclosure, an analysis processing function (for example, an AI model) of the AI assistant is fully deployed on the client, and the server trains the AI model and updates model parameters in a federated learning manner. That is, the server does not reserve user information and data, and is only configured for training the AI model. In the present disclosure, in a process in which user information and data on a client are sent to a server for analysis or processing, the client may send the user information and the data anonymously to the server, that is, the server performs analysis, processing, or AI model training on the information and the data without knowing sources of the information and the data, to protect user privacy.

In conclusion, according to the method provided in this embodiment of the present disclosure, recommendation information content recommended by an AI assistant is obtained and displayed on a UI, so that a user can quickly obtain key information on a social client, and extract effective content from a large amount of information, thereby improving efficiency of processing information content on the social client by the user.

FIG. 7 is a flowchart of an information content processing method according to an exemplary embodiment of the present disclosure. This embodiment is described by using an example in which the method is performed by the terminal device or the client running on the terminal device shown in FIG. 5. For example, a social client onto which a first account is logged is run on the terminal device, and the social client includes at least one social function. The method includes at least one operation of operation 310 to operation 380 below.

In some embodiments, the following operation 310 may be implemented as a pre-performed operation. For example, after the first account is logged onto the social client of the terminal device, the terminal device may perform only the following operations 330 to 380.

Operation 310: Log onto a first account.

The first account is a user account that is currently logged onto the social client.

For example, a user logs onto the first account by clicking a login control after inputting a user name and a password on a login interface; or when a user sets automatic login, the first account is automatically logged onto when the user opens the social client.

Operation 330: Obtain recommendation information content recommended by an AI assistant to the first account.

The AI assistant refers to an AI service that is implemented based on at least an AI model and that is provided in the social client, to improve efficiency of processing information content by the user. Using an example in which an AI service is to process information content, the AI assistant is a recommendation service that filters or summarizes information content based on at least an AI model.

The AI model used by the AI assistant may be a language model, for example, an LLM or a GLM. The model is trained on a large amount of text data, aims to understand and generate a human language, and can perform various tasks such as text summarization, translation, and sentiment analysis. LLM refers to a language model in which model parameters exceed a first threshold, or training data exceeds a second threshold, or a calculation amount exceeds a third threshold, where the first threshold, the second threshold, and the third threshold are each a value at a level of hundred billions. In some embodiments, the AI model used by the AI assistant may alternatively be a model configured for text-to-picture conversion, picture-to-text conversion, text-to-video conversion, or the like. For example, the AI assistant uses a large language model, and provides AI services including summarizing unread social messages, optimizing a social network, backtracking historical social messages, question answering, function recommendation, emotional accompanying, and the like. This is not limited in the present disclosure.

For example, the social client includes a plurality of service functions, and at least two of the plurality of service functions are located at different human-computer interaction interface levels. The service function is a function designed for social networking, and includes at least one of the following: a communication function (including a one-to-one private chat, a group chat, and the like), a contact function, a social circle function, and/or a short video function. Recommendation information content recommended by the AI assistant for a first account is obtained, the recommendation information content including information content obtained after the AI assistant filters or summarizes information content in a first service function, and the first service function being located at a first human-computer interaction interface level.

In some embodiments, the service function of the social client further includes a service function of a third-party application. The third-party application may be a third-party application inside the social client, or may be a third-party application outside the social client. The service function of the third-party application is a service function of the third-party application that the social client is authorized to use or synchronize, that is, the social client has a right to obtain information content in the service function of the authorized third-party application, and/or a right to call a performance function. For example, the social client obtains information content of a third-party application that is in the social client and that is configured for shopping. For another example, the social client calls a performance function of a third-party application that is outside the social client and that is configured for cleaning memory.

The human-computer interaction interface level is configured for indicating reachability of a human-computer interaction interface, that is, operation costs required for reaching the human-computer interaction interface, for example, operations required for going from a main interface of the social client to the human-computer interaction interface. A higher human-computer interaction interface level indicates fewer operations required for a user to reach the human-computer interaction interface.

The filtering means that extraction is performed from the information content in the at least one service function, that is, no secondary processing is performed. The summarizing means that a part of original information content is not directly selected, but general information content such as a summarization or a summary is formed through secondary processing.

For example, the recommendation information content is obtained after the AI assistant filters or summarizes information content in at least one service function. The recommendation information content includes at least one of the following:
first recommendation information content obtained after unread social messages of the first account are filtered or summarized,
second recommendation information content obtained after group chat messages of the first account or to-do items in a workflow are filtered or summarized,
third recommendation information content obtained after candidate information is filtered or summarized according to a preset rule of the first account,
fourth recommendation information content obtained after friend dynamics information in a social network of the first account is filtered or summarized,
fifth recommendation information content randomly recommended to the first account,
fifth recommendation information content obtained after information content in which the first account has a potential interest is filtered or summarized,
sixth recommendation information content obtained after information content that has a sharing probability and that is of the first account is filtered or summarized,
seventh recommendation information content obtained after interest groups in which the first account has a potential interest are filtered or summarized,
eighth recommendation information content obtained after POI information corresponding to a current geographic location of the first account is filtered or summarized;
tenth recommendation information content obtained after AI tools in which the first account has a potential interest are filtered or summarized,
eleventh recommendation information content obtained after games in which the first account has a potential interest are filtered or summarized, and/or
twelfth recommendation information content obtained after related information of third-party applications bound to the first account is filtered or summarized.

A type of information in the foregoing at least one service function may include the following types:
text information such as an SMS message, an x-blog, an x-message, or an email;
picture information such as a photograph, a painting, or an illustration;
video information such as a television program, a movie, or a short video;
audio information such as a song, a broadcast, or a radio station;
social network information such as a personal home page, a social circle, or a social platform;
game information such as an online game or a mobile game;
location information such as GPS positioning or map navigation;
personal information such as personal basic data, interests and hobbies, personality traits, ability levels, or achievements;
group information such as a member composition of a group, a target task, an organization structure, a cultural atmosphere, or a behavior specification;
sentiment information such as an emotional state, attitude tendency, preference, or satisfaction evaluation of an individual or a group;
behavior information such as a behavior manner, a behavior result, or a behavior influence of an individual or a group; and/or
environment information such as a physical environment, a social environment, or a cultural environment in which an individual or a group is located.

For example, in response to a trigger operation on the function portal of the AI function, the recommendation information content recommended by the AI assistant to the first account is obtained. That is, after the first account chooses to use the AI assistant, the recommendation information content obtaining by performing summarization or filtering by the AI assistant is obtained.

For example, information content in at least one service function in the social client is obtained, and by using an AI model (for example, a large language model) on which the AI assistant is based, the information content is summarized, to predict a reply of the first account.

In some embodiments, the recommendation information content recommended by the AI assistant to the first account may be completely generated by the AI model on which the AI assistant is based; or may be combined recommendation information content of recommendation information content generated by the AI model and that generated by using a suitable recommendation algorithm.

In some embodiments, an interest tag library is constructed for each user account, and interest tags in the interest tag library are derived from a use process of the user account in the social client. When determining the recommendation information content of the first account, the AI assistant filters or summarizes the recommendation information content based on interest tags of the first account.

In the technical solution provided in this embodiment of the present disclosure, recommendation information content is obtained by filtering or summarizing different pieces of information content of the first account under different social functions, that is, the recommendation information content can cover different aspects of different service functions in the social application. Therefore, the technical solution provided in this embodiment of the present disclosure reflects diversity of the recommendation information content.

Operation 340: Display the recommendation information content at a second human-computer interaction interface level.

For example, the social client includes a plurality of service functions, and at least two of the plurality of service functions are located at different human-computer interaction interface levels. After the recommendation information content obtained by performing filtering or summarizing by the AI assistant based on the information content in the first service function at the first human-computer interaction interface level is obtained, the recommendation information content recommended by the AI assistant to the first account is displayed at a second human-computer interaction interface level. The second human-computer interaction interface level is higher than the first human-computer interaction interface level. That is, fewer operations are required to reach the second human-computer interaction interface than the first human-computer interaction interface. That is, information content of the first human-computer interaction interface at a lower level is summarized or filtered, and then is displayed on the second human-computer interaction interface at a higher level, so that costs of obtaining the information content are lower, and efficiency is improved.

For example, at least two information cards are displayed at the second human-computer interaction interface level, each of the at least two information cards being configured for displaying one piece or one group of recommendation information content recommended by the AI assistant to the first account. A group of recommendation information content is derived from the same service function; or is derived from the same group chat/contact; or belongs to the same topic. For example, an information summary of unread social messages of a group chat/contact is displayed on each information card. For another example, a filtering result of key information in a service function is displayed on each information card.

The information card includes at least one piece of the following information:
account information of the second account (for example, an avatar of the second account, a nickname of the second account, or a remark name of the first account for the second account);
a quantity of related messages (for example, a quantity of unread messages sent by the second account to the first account);
whether to be filtered or summarized information content (for example, “Already generate a summarization for you” is displayed);
at least one message obtained through filtering (for example, an important message obtained by filtering unread messages);
at least one message obtained through summarization (for example, a message obtained by summarizing unread messages); and
whether to be an identifier of information content processed by the AI model (for example, “AI intelligent message” is displayed).

The at least two information cards may be displayed in a tiled form, or may be displayed in a stacked form. That is, the at least two information cards are tiled and displayed from top to bottom in a non-overlapping manner (a plurality of information cards may be simultaneously displayed on the UI, as shown in FIG. 1), and the user may view different information cards through an up-and-down sliding operation; or the at least two information cards are stacked and displayed in a manner of partial or complete overlapping (only one information card is displayed on the UI, as shown in FIG. 2), and the user may switch different information cards through a sliding operation.

In some embodiments, the at least two information cards are displayed in a tiled manner at the second human-computer interaction interface level, a tiling sequence of the at least two information cards being determined based on recommendation priorities of the at least two information cards.

In some other embodiments, the at least two information cards are displayed in a stacked manner at the second human-computer interaction interface level, a stacking sequence of the at least two information cards being determined based on recommendation priorities of the at least two information cards.

The technical solution provided in this embodiment of the present disclosure provides two manners of displaying information cards. The information cards may be displayed in a tiled manner, or may be displayed in a stacked manner. When the information cards are displayed in the tiled manner, recommendation information content indicated by a plurality of information cards can be known at a time. When the information cards are displayed in the stacked manner, the display area of the information cards can be reduced, thereby reducing display costs of the information cards to some extent.

The recommendation priority may be a default priority of the social client; or may be a user-defined priority; or a priority that is obtained through optimization in a machine learning manner based on a manner in which the user uses the social client. For example, an interest tag library is constructed for each user account, and interest tags in the interest tag library are derived from a use process of the user account in the social client; and a weight of each interest tag is adjusted based on factors such as a use frequency and an interaction frequency of the user account. When determining the recommendation information content of the first account, the AI assistant filters or summarizes the recommendation information content based on interest tags of the first account, and sorts different pieces of recommendation information content based on weights of the interest tags as priorities.

That is, an interest tag of the first account and a weight of the interest tag are obtained; the recommendation priorities of the at least two information cards are determined based on a target interest tag matching the recommendation information content and a weight of the target interest tag; and a sorting sequence of the at least two information cards is determined based on the recommendation priorities of the at least two information cards.

In the technical solution provided in this embodiment of the present disclosure, the recommendation priority of the information card is determined according to the interest tag of the first account and the weight of the interest tag, so that the information card displayed according to the recommendation priority meets the interest of the user, and can hit the requirement of the user, thereby helping improve the display effect of the information card.

In a stacked display manner, the user needs to switch and display different information cards, and the different information cards may be switched by performing a sliding operation. That is, in response to a sliding operation on a first information card of the at least two information cards, display of the first information card is canceled, and a second information card is displayed, the second information card being an information card ranked behind the first information card according to the stacking sequence or the tiling sequence. Alternatively, in response to an upward sliding operation on a first information card of the at least two information cards, display of the first information card is canceled, and a second information card is displayed; and/or in response to a downward sliding operation on a second information card of the at least two information cards, display of the second information card is canceled, and a first information card is displayed. the second information card being an information card ranked behind the first information card according to the stacking sequence or the tiling sequence. In this manner, information cards are switched and displayed by performing a sliding operation, which helps improve switching efficiency and switching flexibility.

In some embodiments, in response to different slide directions on a first information card of the at least two information cards, different second information cards are displayed. For example, upward/downward slide is displaying a former card/latter card of a card of the same type (the same service function), and left/right slide is displaying a former card/latter card of a card of a different type.

In some embodiments, a display level of the recommendation information content recommended by the AI assistant to the first account is higher than a level of a corresponding original function of the recommendation information content. For example, an original function level is the third level, and the display interface of the AI assistant is at the first level, to ensure that the user can reach important information more timely. An example in which the recommendation information content is a summary of unread social messages is used. When the social client is opened, the recommendation information content on the AI assistant interface is displayed, and original unread social messages can be displayed only after successively jumping to a main interface, a contact interface, and a chat interface. Therefore, the AI assistant may enable important information content to be reached by the user earlier.

In some embodiments, each of the information cards corresponds to one service function; each service function registers a card template used by the service function with a scheduling center, and the card template is filled with the recommendation information content, to obtain a card including the recommendation information content, that is, a card template registered by the service function corresponding to the recommendation information content is obtained; and the card template is filled with the recommendation information content, to obtain the information card corresponding to the recommendation information content, and then the information card is displayed on the UI.

In some embodiments, the social client includes a program function corresponding to the AI assistant. A card template registered by at least one service function is received by using the program function corresponding to the AI assistant. The card template is configured for combining with recommendation information content belonging to the service function, to generate and display an information card including the recommendation information content.

In some embodiments, in addition to registering the card template with the scheduling center, the service function further registers a performance function supported by the card template. That is, the social client includes a program function corresponding to the AI assistant, a performance function supported by the card template registered by the at least one service function is received by using the program function corresponding to the AI assistant, the performance function being configured for executing, when being called, a response function corresponding to the recommendation information content.

In the technical solution provided in this embodiment of the present disclosure, by introducing a card template registered by a service function, the card template is filled with recommendation information content, to obtain an information card, thereby facilitating standardized generation of the information card and improving generation efficiency of the information card.

In addition, a program function provided by the program in the AI assistant is configured for receiving a card template registered by each of at least one service function, so as to generate recommendation information content. When a different requirement is imposed on the AI assistant, the program function provided by the AI assistant is changed, thereby helping improve diversity and flexibility of the program function provided by the AI assistant. In addition, the program function receives the card template registered by each of the at least one service function to generate the recommendation information content, which generally has no error, thereby helping improve accuracy of the generated recommendation information content. Further, a performance function supported by the card template registered by each of the at least one service function is received by using the program function corresponding to the AI assistant, the performance function being configured for executing, when being called, a response function corresponding to the recommendation information content. That is, different recommendation information content is quickly generated by registering the performance function and using the response function corresponding to the recommendation information content, which helps improve generation efficiency of the recommendation information content.

In some embodiments, in the process of displaying the recommendation information content, or before or after displaying the recommendation information content, a shortcut operation portal associated with the recommendation information content is displayed; and in response to an operation on the shortcut operation portal, a shortcut processing function corresponding to the shortcut operation portal is executed. That is, while the recommendation information content recommended by the AI assistant to the first account is displayed on the UI of the first account, a shortcut operation portal associated with the recommendation information content is displayed, where a type of the shortcut operation portal and an operation performed by the user on the shortcut operation portal include at least one of the following:
The shortcut operation portal is a jump portal configured for jumping to a function UI of a function to which the recommendation information content belongs, and the first operation is configured for obtaining original information content corresponding to the recommendation information content:

In response to a first operation on the shortcut operation portal, a function UI of a function to which the recommendation information content belongs is displayed, the function UI including original information content corresponding to the recommendation information content.
The shortcut operation portal is a reply portal configured for replying to the second account, and the second operation is configured for replying to a social message:

When the recommendation information content is derived from a social message of the second account, reply content with which the first account replies to the recommendation information content is obtained in response to a second operation on the shortcut operation portal; and a reply message is sent to the second account, the reply message carrying the reply content.
The shortcut operation portal is a reply portal configured for replying to the third account by using quick reply content generated for the recommendation information content, and the third operation is configured for quickly replying to a social message:

When the recommendation information content is derived from a social message of the third account, the quick reply content generated for the recommendation information content is displayed in a process of displaying the recommendation information content; and a reply message is sent to the third account in response to a third operation on the shortcut operation portal, the reply message carrying the quick reply content.
The shortcut operation portal is a jump portal configured for jumping to an item processing interface of to-do items, and the fourth operation is configured for completing a to-do item:

When the recommendation information content is derived from a social message of a fourth account and the social message is associated with a to-do item, an access portal of to-do items is displayed in a process of displaying the recommendation information content; and the item processing interface of to-do items is displayed in response to a fourth operation on the shortcut operation portal (the access portal of to-do items). The to-do items include at least one of an electronic document, a group vote, and a third-party application.
The shortcut operation portal is an access portal configured for accessing multimedia content, and the fifth operation is configured for accessing multimedia content:

When the recommendation information content is associated with multimedia content, an access portal for multimedia content is displayed in a process of displaying the recommendation information content; and in response to a fifth operation on of the shortcut operation portal (the access portal for multimedia content), a multimedia content interface of the multimedia content is displayed. The multimedia content includes at least one of a picture, an audio, a video, and a game.
The shortcut operation portal is a sharing portal configured for sharing recommendation information content with a fifth account or a group, and the sixth operation is configured for sharing:

In a process of displaying the recommendation information content, a sharing portal for sharing the recommendation information content with a fifth account or a group is displayed, the fifth account or the group being recommended by the AI assistant in the social relationship chain of the first account; and the recommendation information content is shared with the fifth account or the group in response to a sixth operation on the shortcut operation portal (the sharing portal).
The shortcut operation portal is an addition portal of a sixth account or a group associated with the recommendation information content, and the seventh operation is configured for adding the sixth account or joining a group chat:

In a process of displaying the recommendation information content, an addition portal of a sixth account or a group associated with the recommendation information content is displayed; and the sixth account is added as a friend or the group is joined in response to a seventh operation on the shortcut operation portal.

In the technical solution provided in this embodiment of the present disclosure, a shortcut operation portal associated with the recommendation information content is displayed; and in response to a different operation on the shortcut operation portal, a different shortcut processing function corresponding to the shortcut operation portal is executed. Therefore, the present disclosure provides shortcut processing functions in the foregoing forms, thereby meeting different requirements of users, enriching human-computer interaction forms, reducing operations, and further reducing device processing overheads.

Operation 360: Receive a command message transmitted by the first account to the AI assistant.

The first account may obtain, through interaction with the AI assistant in a natural language manner, a way to resolve a problem or a related recommendation. That is, the first account sends a command message to the AI assistant, and the social client receives the command message sent by the first account to the AI assistant.

In some embodiments, the first account sends the command message to the AI assistant in a manner of text input or voice input.

In some embodiments, the dialog box in which the first account sends a command message to the AI assistant is located at the bottom of the UI, or the dialog box in which the first account sends a command message to the AI assistant is located inside the information card, for example, at the bottom of the information card. The first account asks a question to or instructs the AI assistant by inputting a command message to the dialog box.

In the technical solution provided in this embodiment of the present disclosure, the command message is sent to the AI assistant by using the first account, to obtain the reply content, thereby enriching human-computer interaction forms, and improving human-computer interaction efficiency. The user may send any command message to the AI assistant, to obtain reply content, thereby improving information obtaining efficiency and simplifying information obtaining operations.

The command message sent by the first account to the AI assistant may include the following types:
Backtrack chat content in a private chat:

A first command message transmitted by the first account to the AI assistant is received, the first command message being configured for asking chat content between the first account and a seventh account. For example, as shown in FIG. 4, an information card is displayed on an AI assistant interface 50, and an identifier “My AI” of information content currently processed by the AI model is displayed on the information card. The first account inputs, in a dialog box 53 in the information card of the AI assistant interface 50, a first command message instructing the AI assistant to backtrack chat content in a private chat, for example, “What did I chat about with friend S recently”, and clicks Send, to send the first command message to the AI assistant. In some embodiments, a voice input control is disposed on a right side of the dialog box 53, that is, the first command message may be inputted in a voice input manner.

In this embodiment of the present disclosure, the first command message is sent to the AI assistant, and first reply content generated for the first command message is received, thereby helping obtain and backtrack chat content in a private chat, improving efficiency of obtaining chat content in a private chat, and simplifying operations of obtaining chat content in a private chat.
Backtrack chat content in a group chat:

A second command message transmitted by the first account to the AI assistant is received, the second command message being configured for asking chat content of a chat group to which the first account belongs. For example, as shown in FIG. 4, an information card is displayed on an AI assistant interface 50, and an identifier “My AI” of information content currently processed by the AI model is displayed on the information card. The first account may click the voice input control in the dialog box 53 and simultaneously input the second command message “What is the conclusion of the previous discussion of the group chat X” in a voice form. After the user releases the voice input control, the second command message is sent to the AI assistant, so that the first account can quickly backtrack information content of the group chat.

In this embodiment of the present disclosure, the second command message is sent to the AI assistant, and second reply content generated for the second command message is received, thereby helping obtain and backtrack chat content in a group chat, improving efficiency of obtaining chat content in a group chat, and simplifying operations of obtaining chat content in a group chat.
Obtain friend dynamics:

A third command message transmitted by the first account to the AI assistant is received, the third command message being configured for asking attention content of an eighth account as a friend of the first account. For example, as shown in FIG. 4, an information card is displayed on an AI assistant interface 50, and an identifier “My AI” of information content currently processed by the AI model is displayed on the information card. The first account inputs, in the dialog box 53 in the information card of the AI assistant interface 50, a third command message instructing the AI assistant to obtain friend dynamics, for example, “What is friend Y concerned about recently” and clicks Send, to send the third command message to the AI assistant, to obtain the recent dynamics of the friend. In some embodiments, a voice input control is disposed on a right side of the dialog box 53, that is, the third command message may be inputted in a voice input manner.

In this embodiment of the present disclosure, the third command message is sent to the AI assistant, and the third reply content generated for the third command message is received, thereby helping obtain friend dynamics, improving efficiency of obtaining the friend dynamics, and simplifying operations of obtaining the friend dynamics.
Obtain keyword information:

A fourth command message transmitted by the first account to the AI assistant is received, the fourth command message being configured for asking network information or social chain information associated with a first keyword. For example, the first keyword is a keyword extracted from the fourth command message. For example, as shown in FIG. 4, an information card is displayed on an AI assistant interface 50, and an identifier “My AI” of information content currently processed by the AI model is displayed on the information card. The first account inputs, in the dialog box 53 in the information card of the AI assistant interface 50, the fourth command message instructing the AI assistant to obtain the keyword information, for example, “What are interest groups related to cosmetics recently” and clicks Send, to send the fourth command message to the AI assistant, to obtain an interest group matching the interest of the first account. In some embodiments, a voice input control is disposed on a right side of the dialog box 53, that is, the fourth command message may be inputted in a voice input manner.

In this embodiment of the present disclosure, the fourth reply content generated for the fourth command message is received by sending the fourth command message to the AI assistant, thereby helping obtain network information or social chain information based on a keyword, improving efficiency of obtaining network information or social chain information, and simplifying operations of obtaining network information or social chain information.
Use a function quickly:

A fifth command message transmitted by the first account to the AI assistant is received, the fifth command message being configured for using a first function. For example, the first function is a function identified from the fifth command message. For example, as shown in FIG. 4, an information card is displayed on an AI assistant interface 50, and an identifier “My AI” of information content currently processed by the AI model is displayed on the information card. The first account inputs, in the dialog box 53 in the information card of the AI assistant interface 50, the fifth command message instructing the AI assistant to help the first account use a function quickly, for example, “Please help me set a teenager mode” and clicks Send, to send the fifth command message to the AI assistant, to obtain an interest group matching the interest of the first account. For another example, “Latest starting of an APP is a bit slow” is inputted to the dialog box 53 in the information card of the AI assistant interface 50 to quickly use a function of clearing cached data. After receiving the fifth command message, the AI assistant generates and displays the reply content 55 and the recommendation-related content 56, so that the user can quickly use, by clicking the recommendation-related content 56, the function of clearing cached data. In some embodiments, a voice input control is disposed on a right side of the dialog box 53, that is, the fifth command message may be inputted in a voice input manner.

In this embodiment of the present disclosure, the fifth command message is sent to the AI assistant, and the fifth reply content generated for the fifth command message is received, thereby helping use the first function quickly, simplifying operations of implementing the first function, and improving device processing efficiency.

Operation 380: Display reply content generated by the AI assistant for the command message.

For example, reply content generated by the AI assistant for the command message is displayed on the UI of the social client, the reply content being obtained after the AI assistant filters or summarizes, based on the command message, information content in the at least one social function.

For different types of command messages in operation 360, the AI assistant generates different pieces of reply content, which are as follows:
Generate first reply content for the first command message:

First reply content generated by the AI assistant for the first command message is displayed, the first reply content being obtained after the AI assistant summarizes the chat content between the first account and the seventh account. For example, the AI assistant determines a tag of the seventh account based on the first command message, performs matching to obtain social message data conforming to the tag, and summarizes the social message data based on the AI model, to generate the first reply content.
Generate second reply content for the second command message:

Second reply content generated by the AI assistant for the second command message is displayed, the second reply content being obtained after the AI assistant summarizes the chat content of the chat group to which the first account belongs. For example, the AI assistant performs matching based on a group chat tag and a content tag in the second command message, to obtain social message data in a group chat conforming to the group chat tag and the content tag, and summarizes the social message data based on the AI model, to generate the second reply content.
Generate third reply content for the third command message:

Third reply content generated by the AI assistant for the third command message is displayed, the third reply content being obtained after the AI assistant summarizes friend dynamics information of the eighth account. For example, the AI assistant performs matching based on a friend tag in the third command message, to obtain dynamics information conforming to the friend tag, and generates the third reply content after filtering or summarizing the dynamics information based on the AI model.
Generate fourth reply content for the fourth command message:

Fourth reply content generated by the AI assistant for the fourth command message is displayed, the fourth reply content being a search result obtained after the AI assistant searches for the network information or the social chain information associated with the first keyword. For example, the AI assistant performs matching based on a first keyword in the fourth command message, to obtain network information or social chain information (for example, an interest group) associated with the first keyword, and generates the fourth reply content after filtering or summarizing the network information or the social chain information.
Generate fifth reply content for the fifth command message:

Fifth reply content generated by the AI assistant for the fifth command message is displayed, the fifth reply content being a function portal that is of the first function and that is fed back by the AI assistant or a call result obtained after the AI assistant calls the first function. For example, the AI assistant determines, based on a keyword in the fifth command message, a function related to the keyword, feeds back a function portal of the function to the first account as a shortcut path, or directly calls the function, and feeds back a call result as the fifth reply content to the first account.

In some embodiments, the interest tag of the first account is obtained based on operation records of the first account on the social client or user information analysis. However, user information (including, but not limited to, personal information, social platform information, location information, social relationship information, and the like) and data (including, but not limited to, data for analysis, stored data, displayed data, and the like) involved in the present disclosure both are information and data that are authorized by a user or fully authorized by all parties. Collection, use, and processing of related data need to comply with relevant laws and regulations of relevant countries and regions. For example, the information such as the social platform information involved in the present disclosure is all obtained under full authorization. For another example, information such as information content involved in the present disclosure is authorized by a user and then obtained, and the user may self-define an authorized private chat/group chat and change settings at any time.

User information and data involved in the present disclosure undergoes sensitive information detection before being analyzed; and undergoes a desensitization operation and then is used and analyzed when sensitive information (for example, a sensitive keyword) is detected. In the present disclosure, the social application is fully deployed on the client, and the server trains the AI model and updates model parameters in a federated learning manner. That is, the server does not reserve user information and data, and is only configured for training the AI model. In the present disclosure, in a process in which user information and data on a client are sent to a server for analysis or processing, the client may send the user information and the data anonymously to the server, that is, the server performs analysis, processing, or AI model training on the information and the data without knowing sources of the information and the data. In conclusion, according to the method provided in this embodiment of the present disclosure, recommendation information content recommended by an AI assistant is displayed on a UI, so that a user can quickly obtain key information on a social client, and extract effective content from a large amount of information, thereby improving efficiency of processing information content on the social client by the user. In addition, the method provided in this embodiment of the present disclosure supports various types of information, supports access of a third-party platform, extends a form of information content, and further improves information content processing efficiency. In addition, according to the method provided in this embodiment of the present disclosure, the user may further quickly obtain a summary of information or a solution to a problem by directly interacting with the AI assistant, thereby improving the use efficiency of the social client.

The social client (that is, the foreground) involved in the present disclosure may be implemented by using a UI component and/or a Hyper Text Markup Language 5 (HTML5) Web front-end of a native system of the client, and is collectively referred to as the foreground. A software architecture of the foreground is shown in the following Table 1:

TABLE 1
Software architecture of the foreground

| | |
|---|---|
| UI layer (View layer) | UI presentation |
| | Interaction logic |
| Business logic layer | Instruction operation distribution |
| | Data conversion mapping |
| Data layer | Persistent data access |
| | Network protocol receiving/transmitting |

The UI layer (View layer) is configured for implementing UI presentation of a UI and interaction logic of a user operation (for example, interaction with the AI assistant). The business logic layer is configured for implementing instruction operation distribution (for example, distribution of a structured operation instruction generated by an AI assistant) and data conversion mapping (for example, operation-to-UI mapping). The data layer is configured for implementing persistent data access (for example, an unread social message of the first account) and network protocol receiving/transmitting.

Based on the architecture shown in the foregoing table, the foreground may implement at least one of the following capabilities:
Implement a card interface including recommendation information content:

Card content is rich text shuffling, which not only presents information, but also provides a shortcut operation. The information form includes a text, a picture, a voice, a video, and the like. The operation form includes a basic element such as a button control, a hyperlink, or an input box, or an element combination that can perform an operation in response to a user touch/click or keyboard input.
Implement diversified dynamics cards including recommendation information content:

Card types are diversified, and are reflected in differences between information, functions, and styles. Different social function modules (services) expand and implement their own card templates based on blank cards, to present information and optional operations specific to the sub-function modules.
Implement a unified structured text instruction:

Different social function modules (services) present, to the outside in a form of a structured text with a unified specification, function operations that the modules can perform, including information such as an operation name, a program function, a parameter list, an optional parameter value, and operation and parameter meanings, so that AI and/or a program generates the structured text accordingly, as an instruction, to express call of the function operations performed by the modules.
Implement cross-service information aggregation and presentation and cross-service function mutual-call by using card information and an instruction operation:

The background, the foreground, and functional modules of the foreground agree on dynamics information of a card that needs to be presented, operations that can be performed, and an interface style in advance, reserve a variable field, encapsulate the variable field into a data structure, fill the data structure with data from the background during running, present the data to an interface, and convert an instruction in response to the data from the background.
Implement a scheduling center responsible for aggregating card data and distributing an instruction operation:

Each sub-function module registers a card supported and implemented by the sub-function module and an instruction operation supported by the sub-function module with the scheduling center (business logic layer); the scheduling center performs matching to obtain a corresponding card according to data received from the background, fills a service card template with the dynamics data and the operation parameter, and presents the service card template to an interface; UI cards of different services are presented on the same page in a tiled/stacked manner; when the scheduling center generates a structured operation instruction according to AI, a user triggers an instruction operation, and distributes the instruction operation to a corresponding sub-function module for function execution; and a related operation feedback is reflected back to the UI.

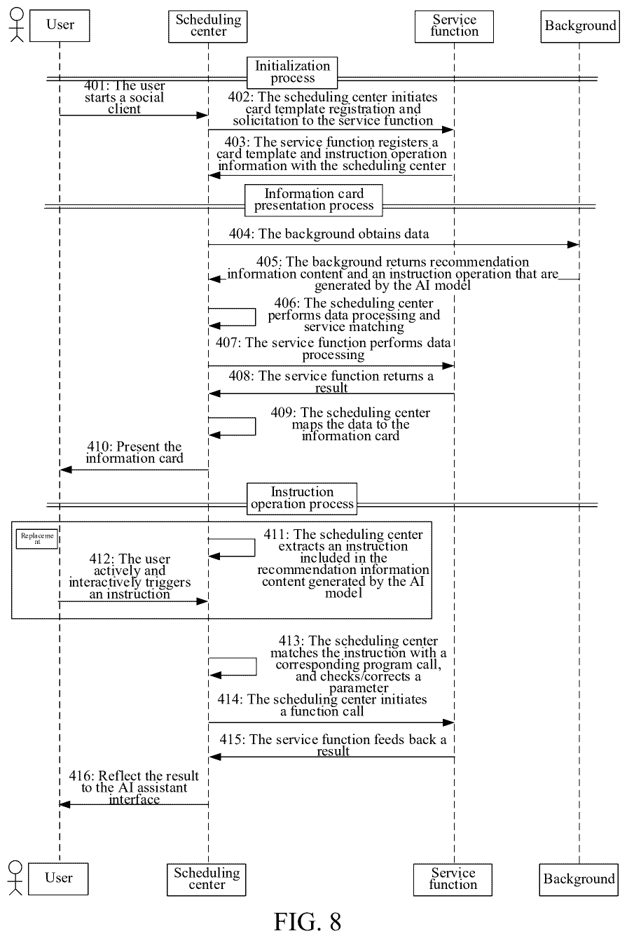

FIG. 8 is a flowchart of data processing of an information content processing method according to an exemplary embodiment of the present disclosure. Bodies involved in FIG. 8 include a user, a scheduling center, a service function, and a background. The flowchart shown in FIG. 7 includes operation 401 to operation 416. Step 401 to operation 403 are an initialization process, operation 404 to operation 410 are an information card presentation process, and operation 411 to operation 416 are an instruction operation process (operation 411 and operation 412 are alternative operations, that is, are alternatively performed).

Initialization process: Step 401 to operation 403: The social function module (the service function) registers, with the scheduling center, a card template of an information card and a performance function supported by the card template.

Operation 401: The user starts a social client.

The user starts the social client by performing a click operation or another trigger operation.

In some embodiments, the user logs onto a first account on the social client.

Operation 402: The scheduling center initiates card template registration and solicitation to the service function.

The scheduling center initiates, to each service function, registration and solicitation of a card template of an information card and a performance function supported by the card template.

Operation 403: The service function registers a card template and instruction operation information with the scheduling center.

Each service function registers, with the scheduling center, a card template of an information card and instruction operation information that are supported and implemented by the service function. For example, the service function registers, with the scheduling center, a card template whose use is supported and a performance function supported by the card template.

For example, a communication function registers, with the scheduling center, a card template configured for summarizing unread social messages in a private chat. The card template includes a message sender, the quantity of messages, summarized message content, and the like. Performance functions supported by the card template include jumping to a private chat interface, making a quick reply, accessing multimedia content, sharing recommendation information content, and the like.

For another example, a communication function registers, with the scheduling center, a card template configured for summarizing unread social messages in a group chat. The card template includes a name of the group chat, a message sender, the quantity of messages, summarized message content, to-do items, and the like. Performance functions supported by the card template include: jumping to a group chat interface, making a quick reply, accessing multimedia content, sharing recommendation information content, accessing a group to-do item, and the like.

For example, a communication function registers, with the scheduling center, a card template configured for backtracking a historical social message in a group chat. The card template includes a name of the group chat, a message sender, a message sending time, summarized message content, and the like. Performance functions supported by the card template include jumping to a group chat interface, accessing multimedia content, and the like.

For another example, a social circle function registers, with the scheduling center, a card template configured for obtaining friend dynamics in a social circle. The card template includes a dynamics message poster, summarized dynamics message content, a picture in a filtered dynamics message, and the like. Performance functions supported by the card template include viewing original content of the dynamics message, quickly replying to the dynamics message, giving a like to the dynamics message, and the like.

For another example, a short video function registers, with the scheduling center, a card template configured for recommending a short video. The card template includes a poster of the short video, a posting time of the short video, a title of the short video, and an access link of the short video. Performance functions supported by the card template include accessing a short video, quickly replying to the short video, giving a like to the short video, and the like.

For another example, a contact function registers, with the scheduling center, a card template configured for recommending a contact. The card template includes an account name of the recommended contact and a relationship between the first account and the recommended contact. Performance functions supported by the card template include accessing a social circle of the recommended contact, quickly adding a friend link, and the like.

Information card presentation process: Step 404 to operation 410 include obtaining data by the background, processing the data, mapping the data to cards, and assembling and presenting the cards.

Operation 404: The background obtains data.

The background obtains data, for example, unread social messages of the first account.

In some embodiments, after obtaining data, the background generates, based on the data by using an AI model, recommendation information content configured for a function of the AI assistant.

Operation 405: The background returns recommendation information content and an instruction operation that are generated by the AI model.

The background returns the recommendation information content and the instruction operation that are generated by the AI model to the scheduling center.

Processing of data returned by the background to the scheduling center includes general processing of the scheduling center (operation 406), and private processing of registration of a social function module (service function) (operation 407 to operation 408). Step 406 and operation 407 to operation 408 are not performed in a particular sequence.

Operation 406: The scheduling center performs data processing and service matching.

The scheduling center performs data processing and service matching on the recommendation information content and the instruction operation that are obtained from the background. That is, the scheduling center receives the recommendation information content obtained from the background, and matches the recommendation information content with each service function according to the data type or the card template of the information card; and extracts the structured instruction generated from the AI model, and generates a corresponding operation button/input box/hyperlink.

In some embodiments, the data processing performed by the scheduling center further includes removing isolated texts, redundant whitespace characters, and the like.

Operation 407: The service function performs data processing.

The scheduling center sends the recommendation information content obtained from the background to each service function, so that each service function performs private processing of registration of the service function. For example, isolated texts, redundant whitespace characters, and the like are removed according to the card template registered by the service function.

Operation 408: The service function returns a result.

Each service function performs private processing on the recommendation information content, and then sends processed result data to the scheduling center.

Operation 409: The scheduling center maps the data to the information card.

The scheduling center maps data of processed recommendation information content to the information card, that is, the scheduling center instantiates a UI (including the information card and the operation button).

For example, the scheduling center performs matching to obtain a corresponding card template View according to the data of the processed recommendation information content, and maps the card template from a data Model to a View Model.

Operation 410: Present the information card.

After mapping the data of the recommendation information content to the information card, the scheduling center presents the information card to the user, that is, displays the information card including the recommendation information content on an AI assistant interface.

Instruction operation process: Step 411 to operation 416 include triggering an instruction operation, matching a corresponding program call, checking/correcting a parameter, calling a function, and reflecting a result feedback to the AI assistant interface.

There are two trigger ways to trigger the instruction operation. The first way is that a program automatically performs the instruction operation automatically extracted from the AI result returned by the background (that is, operation 411), and the second way is that the user actively clicks an interaction element including the instruction operation (that is, operation 412).

Operation 411: The scheduling center extracts an instruction included in the recommendation information content generated by the AI model.

The scheduling center automatically extracts, from the recommendation information content generated by the AI model, an instruction included in the recommendation information content.

Operation 412: The user actively and interactively triggers an instruction.

The user actively triggers an interaction element including an instruction operation, for example, clicks a control on the AI assistant interface, to trigger the instruction.

Operation 413: The scheduling center matches the instruction with a corresponding program call, and checks/corrects a parameter.

After the instruction is triggered, the scheduling center matches the instruction with a corresponding program call, and checks and/or corrects a parameter.

For example, after receiving an operation instruction actively triggered by the user or automatically extracted by AI, the scheduling center matches each service function with a performance function of the corresponding service function according to registration information of the service function, and converts the instruction into a program call. Because there is a deviation or an error in content or structured syntax generated by the AI model, the content needs to be checked and corrected, and a call is initiated after a filling parameter is checked/corrected.

Operation 414: The service function initiates a function call.

The function call of the service function is derived from a fixed template of a card including the recommendation information content, or is dynamically generated by extracting a structured instruction from a result returned by the background AI. A call parameter is derived from AI recommendation (that is, the parameter is optimized and recommended by using the AI model) and/or is user-specified (that is, user-defined).

For example, the service function initiates a function call supported by the service function.

Operation 415: The service function feeds back a result.

After a function call, the service function returns a result of the function call to the scheduling center.

Operation 416: Reflect the result to the AI assistant interface.

The scheduling center reflects the received result of the function call of the service function to the AI assistant interface, that is, displays the recommendation information content of the AI assistant on the AI assistant interface.

The background involved in the present disclosure includes a business logic layer, an algorithm layer, and a recommendation layer. An input source of the background is a group chat/contact authorized by the user.

The business logic layer is configured for implementing at least one of the following functions:
reading, according to a group chat/contact selected by the user, a group chat message in a database that is not read by the user, content that mentions the user in the group chat, a contact message, a dynamics message, and the like;
asynchronously parsing message content of each group chat/contact, including a sender, a sending time, sent content (including a text, a picture, a voice, a video, a file, and a link) of each message;
sending the parsed content to the algorithm layer, where the algorithm layer includes an algorithm for generating the recommendation information content by using the AI model; and the algorithm layer appropriately summarizes these messages, and predicts a reply that the user may make, to return content to the business logic layer;
uniformly pushing the content returned by the algorithm layer to the recommendation layer, where the recommendation layer sorts the content and makes a recommendation to the user, where recommended content includes, but is not limited to: a priority of the recommendation information content, a link in which the user may be interested, a group chat in which the user may be interested, and the like; and/or
returning the recommendation information content to the social client by using the business logic layer.

The algorithm layer is configured for performing summarization according to the message content sent by the business logic layer and predicting a reply that the user may make. A message source includes but is not limited to: a contact message, content of the first account (@ the first account) mentioned in a group chat, and content of all members (@ all) mentioned in a group chat. The message form includes but is not limited to: a text, a picture, a voice, a video, a file, and a link.

The recommendation layer is configured for recommending content of the algorithm layer according to content in which the user is interested, and additionally recommending some disclosed links, groups, functions, and the like in which the user may be interested.

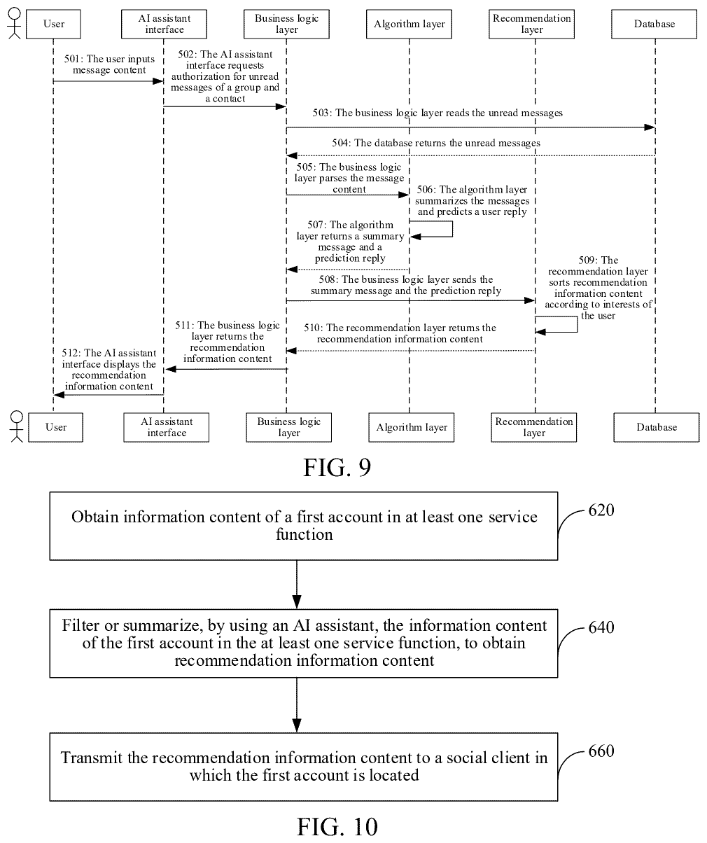

FIG. 9 is a timing diagram of an information content processing method according to an exemplary embodiment of the present disclosure. Bodies involved in FIG. 9 include a user, an AI assistant interface, a business logic layer, an algorithm layer, a recommendation layer, and a database.

Operation 501: The user inputs message content.

The user inputs message content on the AI assistant interface, for example, asks an AI assistant about a summary of unread messages in a group chat/contact.

Operation 502: The AI assistant interface requests authorization for unread messages of a group and a contact.

After receiving an input message of the user, to obtain unread messages in a corresponding group chat/contact, the AI assistant interface needs to request authorization from the business logic layer to obtain the unread messages of the group and the contact.

Operation 503: The business logic layer reads the unread messages.

The business logic layer reads, from the database, the authorized unread messages in the group chat/contact, including content such as content that mentions the user in the group chat and contact messages.

Operation 504: The database returns the unread messages.

The authorized unread messages in the group chat/contact in the database are returned to the business logic layer.

Operation 505: The business logic layer parses the message content.

The business logic layer asynchronously parses the message content of each group chat/contact obtained in operation 504, where the message content includes a sender, a sending time, sent content (including a text, a picture, a voice, a video, a file, and a link) of each message; and then sends the parsed content to the algorithm layer.

Operation 506: The algorithm layer summarizes the messages and predicts a user reply.

The algorithm layer summarizes, based on the message content parsed by the business logic layer, the message content according to an AI language model, and predicts a reply that the user may use.

Operation 507: The algorithm layer returns a summary message and a prediction reply.

The algorithm layer returns the summary message and the prediction reply (that is, an output result of the AI language model) to the business logic layer.

Operation 508: The business logic layer sends the summary message and the prediction reply.

The business logic layer uniformly pushes the content returned by the algorithm layer to the recommendation layer, and the recommendation layer sorts the content and makes a recommendation to the user, where

Operation 509: The recommendation layer sorts recommendation information content according to interests of the user.

The recommendation layer sorts the recommendation information content based on the recommendation information content (that is, the summary message and the prediction reply) outputted by the AI language model. recommended content includes, but is not limited to: a returning sequence of the recommendation information content (that is, a priority displayed on the AI assistant interface), a link in which the user may be interested, a group chat in which the user may be interested, and the like.

A sorting algorithm of the recommendation layer may be user-defined, or may be obtained through optimization for the user by using the AI model.

In addition, the recommendation layer additionally recommends some disclosed links, groups, functions, and the like in which the user may be interested to the user according to user information.

Operation 510: The recommendation layer returns the recommendation information content.

The recommendation layer returns the sorted recommendation information content to the business logic layer.

Operation 511: The business logic layer returns the recommendation information content.

After obtaining the recommendation information content returned by the recommendation layer, the business logic layer pushes the recommendation information content to the AI assistant interface.

Operation 512: The AI assistant interface displays the recommendation information content.

The sorted recommendation information content is displayed on the AI assistant interface.

FIG. 10 is a flowchart of an information content processing method according to an exemplary embodiment of the present disclosure. This embodiment is described by using an example in which the method is performed by the terminal device, the client running on the terminal device, or the server shown in FIG. 5. For example, a social client onto which a first account is logged is run on the terminal device. The method includes at least one operation of operation 620 to operation 660 below.

Operation 620: Obtain information content of a first account in at least one service function.

The first account is a user account that is currently logged onto the social client.

The social client includes at least one service function. The service function is a function designed for social networking, and includes at least one of the following: a communication function (including a one-to-one private chat, a group chat, and the like), a contact function, a social circle function, and a short video function.

For example, a type of information in the at least one service function may include the following types:
text information such as an SMS message, an x-blog, an x-message, or an email;
picture information such as a photograph, a painting, or an illustration;
video information such as a television program, a movie, or a short video;
audio information such as a song, a broadcast, or a radio station;
social network information such as a personal home page, a social circle, or a social platform;
game information such as an online game or a mobile game;
location information such as GPS positioning or map navigation;
personal information such as personal basic data, interests and hobbies, personality traits, ability levels, or achievements;
group information such as a member composition of a group, a target task, an organization structure, a cultural atmosphere, or a behavior specification;
sentiment information such as an emotional state, attitude tendency, preference, or satisfaction evaluation of an individual or a group;
behavior information such as a behavior manner, a behavior result, or a behavior influence of an individual or a group; and/or
environment information such as a physical environment, a social environment, or a cultural environment in which an individual or a group is located.

In some embodiments, the information content may be an unread social message of the first account, a social message related to the first account in a group chat, a social message related to all members in a group chat, a contact of the first account, a group chat of the first account, social dynamics of the first account and a user account on a social chain of the first account, short videos posted by the first account and a user account on a social chain of the first account, interest tags of the first account and a user account on a social chain of the first account, or the like.

In some embodiments, the information content of the first account in the at least one service function is obtained from the database. For example, the unread social message of the first account is obtained from the database.

In some embodiments, an interest tag library is constructed for each user account, and interest tags in the interest tag library are derived from a use process of the user account in the social client. Information content that is related to an interest tag of the first account and that is in the at least one service function is obtained according to the interest tag.

Operation 640: Filter or summarize, by using an AI assistant, the information content of the first account in the at least one service function, to obtain recommendation information content.

The AI assistant is a recommendation service that filters or summarizes information content based on at least an AI model. The AI model used by the AI assistant may be a language model, for example, an LLM or a GLM. The model is trained on a large amount of text data, aims to understand and generate a human language, and can perform various tasks such as text summarization, translation, and sentiment analysis. LLM refers to a language model in which model parameters exceed a first threshold, or training data exceeds a second threshold, or a calculation amount exceeds a third threshold, where the first threshold, the second threshold, and the third threshold are each a value at a level of hundred billions. In some embodiments, the AI model used by the AI assistant may be a model configured for text-to-picture conversion, picture-to-text conversion, text-to-video conversion, or the like. For example, the AI assistant uses a large language model, and provides AI services including summarizing unread social messages, optimizing a social network, backtracking historical social messages, question answering, function recommendation, emotional accompanying, and the like. This is not limited in the present disclosure.

The recommendation information content recommended by the AI assistant to the first account may be completely generated by the AI model on which the AI assistant is based; or may be combined recommendation information content of recommendation information content generated by the AI model and that generated by using a suitable recommendation algorithm. The present disclosure does not completely limit all recommendation information content to being generated by the AI model used by the AI assistant.

The recommendation information content is obtained after the AI assistant filters or summarizes information content in at least one service function. The filtering means that extraction is performed from the information content in the at least one service function, that is, no secondary processing is performed. The summarizing means that a part of original information content is not directly selected, but general information content such as a summarization or a summary is formed through secondary processing.

The recommendation information content includes at least one of the following:
first recommendation information content obtained after unread social messages of the first account are filtered or summarized, where for example, unread social messages in a chat list are filtered or summarized, to form the first recommendation information content, and the unread social messages may be unread social messages in a private chat, or unread social messages in a group chat, or unread social messages in a private chat/group chat specified by the first account, or unread social messages in a private chat/group chat whose quantity of unread social messages exceeds a number threshold;
second recommendation information content obtained after group chat messages of the first account or to-do items in a workflow are filtered or summarized, where for example, work arranged in a work group chat or information to which a reply needs to be made is selected, through filtering, as the second recommendation information content; for another example, a to-do item such as a group vote, a group file, or a group announcement is used as the second recommendation information content; for another example, a message that mentions the first account in a group chat or a message that mentions all members in a group chat is used as the second recommendation information content;
third recommendation information content obtained after candidate information is filtered or summarized according to a preset rule of the first account, where the user may self-define the recommendation information content; for example, the first account presets objects that need to be filtered or summarized by the AI assistant, and specifies a filtering or summarizing time range, a type of information content, and the like; for example, information content whose type is a document in the last year is filtered or summarized; for another example, dynamics messages of a dynamics space in the last month are filtered or summarized;
fourth recommendation information content obtained after friend dynamics information in a social network of the first account is filtered or summarized, where for example, the fourth recommendation information content is a dynamics update of a friend in a social circle; for another example, the fourth recommendation information content is a birthday reminder of a friend;
fifth recommendation information content randomly recommended to the first account, where for example, the fifth recommendation information content is hot news recommended by the first account; for another example, the fifth recommendation information content is information content that a friend of the first account is concerned about; or
fifth recommendation information content obtained after information content in which the first account has a potential interest is filtered or summarized, where for example, an interest tag of the first account is determined based on a topic that the first account is concerned about, and information content in which the first account may be interested is determined according to the interest tag, and is filtered or summarized and then recommended to the first account; for another example, a recommendation is made to the first account based on information content of the entire network platform on that day; for example, in a short video function, all hot short videos on that day are filtered or summarized;
sixth recommendation information content obtained after information content that has a sharing probability and that is of the first account is filtered or summarized, where for example, an interest tag of the first account or hot information that is concerned about is determined based on chat content between the first account and a friend of the first account, and information content related to the interest tag or the hot information that is concerned about is filtered or summarized and then recommended to the first account; for another example, the first account is supported in self-defining information content having a sharing probability, and is authorized to share the information content with a friend or a group chat;
seventh recommendation information content obtained after interest groups in which the first account has a potential interest are filtered or summarized, where for example, candidate interest groups in which the first account may be interested are determined based on the interest tag of the first account, and an interest group obtained by filtering or summarizing the candidate interest groups is recommended to the first account as the seventh recommendation information content;
eighth recommendation information content obtained after POI information corresponding to a current geographic location of the first account is filtered or summarized; POI refers to point data on an Internet electronic map, and includes four attributes: a name, an address, a coordinate, and a category; for example, based on a current geographic location of the first account, merchant information, transportation services, and the like that are near the current geographic location and in which the first account may be interested are filtered or summarized, and are recommended to the first account as the eighth recommendation information content;
ninth recommendation information content obtained after strange accounts in which the first account has a potential interest are filtered or summarized, where for example, candidate accounts having interest tags the same as that of the first account are determined, the candidate accounts have a potential interest in the first account, and a candidate account obtained by filtering or summarizing the candidate accounts is recommended to the first account as the ninth recommendation information content;
tenth recommendation information content obtained after AI tools in which the first account has a potential interest are filtered or summarized, where the AI tool is a tool that is developed based on the AI technology and that is configured for solving a problem; for example, candidate AI tools in which the first account may be interested are determined based on the interest tag of the first account, and an AI tool obtained by filtering or summarizing the candidate tools is recommended to the first account as the tenth recommendation information content; for another example, if the interest tag of the first account is painting, an AI painting tool is recommended to the first account and a shortcut operation portal is provided;
eleventh recommendation information content obtained after games in which the first account has a potential interest are filtered or summarized, where for example, candidate games in which the first account may be interested are determined, and a game obtained by filtering or summarizing the candidate games is recommended to the first account as the eleventh recommendation information content; and/or
twelfth recommendation information content obtained after related information of third-party applications bound to the first account is filtered or summarized, where for example, preferential information obtained after preferential information of takeout software bound to the first account is filtered or summarized is recommended to the first account as the twelfth recommendation information content.

For example, the information content of the first account in the at least one service function is filtered or summarized by calling the AI model on which the AI assistant is based, to obtain recommendation information content.

Operation 660: Transmit the recommendation information content to a social client in which the first account is located.

For example, after the recommendation information content generated by the AI model on which the AI assistant is based is obtained, the recommendation information content is sent to the first account, and the recommendation information content is displayed on the AI assistant interface of the first account.

In some embodiments, a card template registered by the service function corresponding to the recommendation information content is sent while the recommendation information content is sent to the first account; and after the card template is filled with the recommendation information content, the recommendation information content is displayed on the AI assistant interface of the first account.

In conclusion, according to the method provided in this embodiment of the present disclosure, information content from a social client is obtained and recommendation information content is determined based on the information content, so that a user can quickly obtain key information on a social client, and extract effective content from a large amount of information, thereby improving efficiency of processing information content on the social client by the user.

The information content processing method involved in the present disclosure is widely applied to various scenarios. Using a customer service scenario of an e-commerce industry as an example, because the customer service interfaces or communicates with a large quantity of customers every day, a social client of the customer service receives a large quantity of messages. However, the information density of these messages may be not large, for example, a plurality of messages may actually be summarized as one sentence. In addition, most content of the information is similar, for example, query for express information, urge for delivery, and request for return. In this scenario, customer service processing efficiency is improved by using the information content processing method of the present disclosure.

For example, a first account of a customer service is logged onto; recommendation information content recommended by an AI assistant to the first account of the customer service is obtained, the recommendation information content being obtained after the AI assistant filters or summarizes information content of the first account of the social client in at least one service function; and the recommendation information content is displayed. For example, after the customer service logs onto the first account, recommendation information content recommended by the AI assistant for the first account is obtained. The recommendation information content is a summary of unread messages. The recommendation information content is displayed on the AI assistant interface of the first account.

For example, at least two information cards are displayed, each of the at least two information cards being configured for displaying one piece or one group of recommendation information content recommended by the AI assistant to the first account. That is, the recommendation information content is displayed on the AI assistant interface in a form of an information card including the recommendation information content; and each information card displays a summary of messages from a customer, or each message card displays requirements of the same type from different customers (for example, return requests of different customers).

For example, the at least two information cards are displayed in a tiled manner, a tiling sequence of the at least two information cards being determined based on recommendation priorities of the at least two information cards.

For example, the at least two information cards are displayed in a stacked manner, a stacking sequence of the at least two information cards being determined based on recommendation priorities of the at least two information cards.

That is, a plurality of information cards may be displayed in a tiled (non-overlapped) or stacked (partially or completely overlapped) manner; and a display sequence of the information cards is determined based on recommendation priorities, and the recommendation priorities are user-defined or obtained through AI optimization.

For example, in response to a sliding operation on a first information card of the at least two information cards, display of the first information card is canceled, and a second information card is displayed, the second information card being an information card ranked behind the first information card according to the stacking sequence or the tiling sequence. That is, when the information cards are displayed in a stacked manner or displayed in a tiled manner, different information cards are switched and displayed by performing a sliding operation.

For example, the recommendation information content recommended to the first account of the customer service includes at least one of the following:
first recommendation information content obtained after unread social messages of the first account are filtered or summarized,
second recommendation information content obtained after group chat messages of the first account or to-do items in a workflow are filtered or summarized,
third recommendation information content obtained after candidate information is filtered or summarized according to a preset rule of the first account,
fourth recommendation information content obtained after friend dynamics information in a social network of the first account is filtered or summarized,
fifth recommendation information content randomly recommended to the first account,
fifth recommendation information content obtained after information content in which the first account has a potential interest is filtered or summarized,
sixth recommendation information content obtained after information content that has a sharing probability and that is of the first account is filtered or summarized,
seventh recommendation information content obtained after interest groups in which the first account has a potential interest are filtered or summarized,
eighth recommendation information content obtained after POI information corresponding to a current geographic location of the first account is filtered or summarized;
ninth recommendation information content obtained after strange accounts in which the first account has a potential interest are filtered or summarized,
tenth recommendation information content obtained after AI tools in which the first account has a potential interest are filtered or summarized,
eleventh recommendation information content obtained after games in which the first account has a potential interest are filtered or summarized, and/or
twelfth recommendation information content obtained after related information of third-party applications bound to the first account is filtered or summarized.

For example, in response to a first operation on the recommendation information content, a function UI of a function to which the recommendation information content belongs is displayed, the function UI including original information content corresponding to the recommendation information content. That is, the customer service may jump to an original interface of the recommendation information content by clicking the recommendation information content, for example, jump to a chat interface between the customer service and the customer by clicking a summary of unread messages of the customer.

For example, the recommendation information content is derived from a social message of the second account, and reply content with which the first account replies to the recommendation information content is obtained in response to a second operation on the recommendation information content; and a reply message is sent to the second account, the reply message carrying the reply content. That is, the customer service may directly input the reply message for the second account on the AI assistant interface and send the reply message.

For example, the recommendation information content is derived from a social message of the third account, and the quick reply content generated for the recommendation information content is displayed in a process of displaying the recommendation information content; and a reply message is sent to the third account in response to a third operation on the quick reply content, the reply message carrying the quick reply content. That is, the AI assistant interface further displays a quick reply message recommended to the customer service, and the customer service may click the quick reply message on the AI assistant interface in some embodiments, to make a quick reply.

For example, the recommendation information content is derived from a social message of a fourth account and the social message is associated with a to-do item, and an access portal of to-do items is displayed in a process of displaying the recommendation information content; and the item processing interface of to-do items is displayed in response to a fourth operation on the access portal. The to-do items include at least one of an electronic document, a group vote, and a third-party application. For example, for a to-do item (for example, filling in a return form), a link of the return form is displayed on the AI assistant interface, so that the customer service can access the return form with one click.

For example, the recommendation information content is associated with multimedia content, and an access portal for multimedia content is displayed in a process of displaying the recommendation information content; and in response to a fifth operation on of the access portal, a multimedia content interface of the multimedia content is displayed. The multimedia content includes at least one of a picture, an audio, a video, and a game. For example, if the recommendation information content is associated with a presentation picture of a commodity, an access portal of a picture presentation page of the commodity is displayed on the AI assistant interface.

For example, in a process of displaying the recommendation information content, a sharing portal for sharing the recommendation information content with a fifth account or a group is displayed, the fifth account or the group being recommended by the AI assistant in the social relationship chain of the first account; and the recommendation information content is shared with the fifth account or the group in response to a sixth operation on the sharing portal. For example, a sharing portal for sharing a commodity is displayed on the AI assistant interface of the customer service, and the customer service can quickly share, with a potential customer, a commodity that the potential customer may purchase.

For example, a command message transmitted by the first account to the AI assistant is received; and reply content generated by the AI assistant for the command message is displayed, the reply content being obtained after the AI assistant filters or summarizes, based on the command message, information content in the at least one service function. For example, the customer service may ask the AI assistant about a summary of chats with the customer, and the AI assistant generates reply content and displays the reply content on the AI assistant interface.

In some embodiments, the command message sent by the first account to the AI assistant may include the following types:
Backtrack chat content in a private chat:

A first command message transmitted by the first account to the AI assistant is received, the first command message being configured for asking chat content between the first account and a seventh account. First reply content generated by the AI assistant for the first command message is displayed, the first reply content being obtained after the AI assistant summarizes the chat content between the first account and the seventh account.
Backtrack chat content in a group chat:

A second command message transmitted by the first account to the AI assistant is received, the second command message being configured for asking chat content of a chat group to which the first account belongs. Second reply content generated by the AI assistant for the second command message is displayed, the second reply content being obtained after the AI assistant summarizes the chat content of the chat group to which the first account belongs.
Obtain friend dynamics:

A third command message transmitted by the first account to the AI assistant is received, the third command message being configured for asking attention content of an eighth account as a friend of the first account. Third reply content generated by the AI assistant for the third command message is displayed, the third reply content being obtained after the AI assistant summarizes friend dynamics information of the eighth account.
Obtain keyword information:

A fourth command message transmitted by the first account to the AI assistant is received, the fourth command message being configured for asking network information or social chain information associated with a first keyword. Fourth reply content generated by the AI assistant for the fourth command message is displayed, the fourth reply content being a search result obtained after the AI assistant searches for the network information or the social chain information associated with the first keyword.
Use a function quickly:

A fifth command message transmitted by the first account to the AI assistant is received, the fifth command message being configured for using a first function. Fifth reply content generated by the AI assistant for the fifth command message is displayed, the fifth reply content being a function portal that is of the first function and that is fed back by the AI assistant or a call result obtained after the AI assistant calls the first function.

For example, a function portal of a function of the AI assistant is displayed; and in response to a trigger operation on the function portal, the recommendation information content recommended by the AI assistant to the first account is displayed. That is, the customer service enables a function of the AI assistant by clicking the function portal of the function of the AI assistant.

For example, each of the information cards corresponds to one service function; a card template registered by the service function corresponding to the recommendation information content is obtained; and the card template is filled with the recommendation information content, to obtain the information card corresponding to the recommendation information content. For example, an after-sale request, a group chat message, and a social circle of a customer respectively correspond to different card templates, and corresponding card templates are respectively filled with recommendation information content belonging to different service functions, to obtain information cards corresponding to the recommendation information content.

For example, the social client includes a program function corresponding to the AI assistant, and a card template registered by the at least one service function is received by using the program function corresponding to the AI assistant.

For example, the social client includes a program function corresponding to the AI assistant, and a performance function supported by the card template registered by the at least one service function is received by using the program function corresponding to the AI assistant, the performance function being configured for executing, when being called, a response function corresponding to the recommendation information content.

For example, an interest tag of the first account and a weight of the interest tag are obtained; the recommendation priorities of the at least two information cards are determined based on a target interest tag matching the recommendation information content and a weight of the target interest tag; and a sorting sequence of the at least two information cards is determined based on the recommendation priorities of the at least two information cards.

For example, obtaining information content of a first account in at least one service function; the information content in the at least one service function is filtered or summarized by using an AI assistant, to obtain recommendation information content, the AI assistant being a recommendation service that filters or summarizes information content based on at least an AI model; and Transmit the recommendation information content to a social client in which the first account is located.

The following is an apparatus embodiment of the present disclosure, which can be configured for performing the method embodiments of the present disclosure. For details not disclosed in the apparatus embodiment of the present disclosure, refer to the method embodiments of the present disclosure.

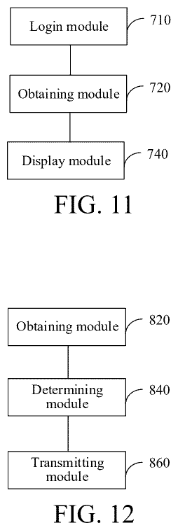

FIG. 11 is a structural block diagram of an information content processing apparatus according to an exemplary embodiment of the present disclosure. The apparatus may be a terminal device, or may be arranged in a terminal device.

In some embodiments, the apparatus includes a login module 710, where the login module 710 is configured to log onto a first account; an obtaining module 720, configured to obtain recommendation information content recommended by an AI assistant for a first account, the recommendation information content being obtained after the AI assistant filters or summarizes information content of the first account in at least one service function; and a display module 740, configured to display the recommendation information content.

In some embodiments, a social client is logged onto the apparatus, the social client includes a plurality of service functions, and at least two of the plurality of service functions are located at different human-computer interaction interface levels; the obtaining module 720 is configured to obtain recommendation information content recommended by the AI assistant for a first account, the recommendation information content including information content obtained after the AI assistant filters or summarizes information content of the first account in a first service function, and the first service function being located at a first human-computer interaction interface level; and the display module 740 is configured to display the recommendation information content at a second human-computer interaction interface level, the second human-computer interaction interface level being higher than the first human-computer interaction interface level.

In some embodiments, the display module 740 is configured to display at least two information cards at the second human-computer interaction interface level, each of the at least two information cards being configured for displaying one piece or one group of recommendation information content recommended by the AI assistant to the first account.

In some embodiments, the display module 740 is configured to display the at least two information cards in a tiled manner at the second human-computer interaction interface level, a tiling sequence of the at least two information cards being determined based on recommendation priorities of the at least two information cards.

In some embodiments, the display module 740 is configured to display the at least two information cards in a stacked manner at the second human-computer interaction interface level, a stacking sequence of the at least two information cards being determined based on recommendation priorities of the at least two information cards.

In some embodiments, the display module 740 is configured to cancel, in response to a sliding operation on a first information card of the at least two information cards, display of the first information card, and display a second information card, the second information card being an information card ranked behind the first information card according to the stacking sequence or the tiling sequence.

In some embodiments, the recommendation information content includes at least one of the following: first recommendation information content obtained after unread social messages of the first account are filtered or summarized; second recommendation information content obtained after group chat messages of the first account or to-do items in a workflow are filtered or summarized; third recommendation information content obtained after candidate information is filtered or summarized according to a preset rule of the first account; fourth recommendation information content obtained after friend dynamics information in a social network of the first account is filtered or summarized; fifth recommendation information content randomly recommended to the first account; or fifth recommendation information content obtained after information content in which the first account has a potential interest is filtered or summarized; sixth recommendation information content obtained after information content that has a sharing probability and that is of the first account is filtered or summarized; seventh recommendation information content obtained after interest groups in which the first account has a potential interest are filtered or summarized; eighth recommendation information content obtained after POI information corresponding to a current geographic location of the first account is filtered or summarized; ninth recommendation information content obtained after strange accounts in which the first account has a potential interest are filtered or summarized; tenth recommendation information content obtained after AI tools in which the first account has a potential interest are filtered or summarized; eleventh recommendation information content obtained after games in which the first account has a potential interest are filtered or summarized; and/or twelfth recommendation information content obtained after related information of third-party applications bound to the first account is filtered or summarized.

In some embodiments, the display module 740 is configured to: display a shortcut operation portal associated with the recommendation information content; and execute, in response to an operation on the shortcut operation portal, a shortcut processing function corresponding to the shortcut operation portal.

In some embodiments, the shortcut operation portal is a jump portal configured for jumping to a function UI of a function to which the recommendation information content belongs; and the display module 740 is configured to display, in response to a first operation on the shortcut operation portal, a function UI of a function to which the recommendation information content belongs, the function UI including original information content corresponding to the recommendation information content.

In some embodiments, the recommendation information content is derived from a social message of a second account, and the shortcut operation portal is a reply portal configured for replying to the second account; and the display module 740 is configured to obtain, in response to a second operation on the shortcut operation portal, reply content with which the first account replies to the recommendation information content; and send a reply message to the second account, the reply message carrying the reply content.

In some embodiments, the recommendation information content is derived from a social message of a third account, and the shortcut operation portal is a reply portal configured for replying to the third account by using quick reply content generated for the recommendation information content; and the display module 740 is configured to send a reply message to the third account in response to a third operation on the shortcut operation portal, the reply message carrying the quick reply content.

In some embodiments, the recommendation information content is derived from a social message of a fourth account, the social message is associated with a to-do item, and the shortcut operation portal is a jump portal configured for jumping to an item processing interface of to-do items; and the display module 740 is configured to display the item processing interface of to-do items in response to a fourth operation on the shortcut operation portal. The to-do items include at least one of an electronic document, a group vote, and a third-party application.

In some embodiments, the recommendation information content is associated with multimedia content, and the shortcut operation portal is an access portal configured for accessing multimedia content; and the display module 740 is configured to display a multimedia content interface of the multimedia content in response to a fifth operation on of the shortcut operation portal. The multimedia content includes at least one of a picture, an audio, a video, and a game.

In some embodiments, the shortcut operation portal is a sharing portal configured for sharing recommendation information content with a fifth account or a group; and the display module 740 is configured to share the recommendation information content with the fifth account or the group in response to a sixth operation on the shortcut operation portal, where the fifth account or the group being recommended by the AI assistant in the social relationship chain of the first account.

In some embodiments, the shortcut operation portal is an addition portal of a sixth account or a group associated with the recommendation information content; and the display module 740 is configured to add the sixth account as a friend or the group is joined in response to a seventh operation on the shortcut operation portal.

In some embodiments, the display module 740 is configured to receive a command message transmitted by the first account to the AI assistant; and display reply content generated by the AI assistant for the command message, the reply content being obtained after the AI assistant filters or summarizes, based on the command message, information content of the first account in the at least one social function.

In some embodiments, the display module 740 is configured to receive a first command message transmitted by the first account to the AI assistant, the first command message being configured for asking chat content between the first account and a seventh account; and display first reply content generated by the AI assistant for the first command message, the first reply content being obtained after the AI assistant filters or summarizes the chat content between the first account and the seventh account.

In some embodiments, the display module 740 is configured to receive a second command message transmitted by the first account to the AI assistant, the second command message being configured for asking chat content of a chat group to which the first account belongs; and display second reply content generated by the AI assistant for the second command message, the second reply content being obtained after the AI assistant filters or summarizes the chat content of the chat group to which the first account belongs.

In some embodiments, the display module 740 is configured to receive a third command message transmitted by the first account to the AI assistant, the third command message being configured for asking attention content of an eighth account as a friend of the first account; and display third reply content generated by the AI assistant for the third command message, the third reply content being obtained after the AI assistant filters or summarizes friend dynamics information of the eighth account.

In some embodiments, the display module 740 is configured to receive a fourth command message transmitted by the first account to the AI assistant, the fourth command message being configured for asking network information or social chain information associated with a first keyword; and display fourth reply content generated by the AI assistant for the fourth command message, the fourth reply content being a search result obtained after the AI assistant searches for the network information or the social chain information associated with the first keyword.

In some embodiments, the display module 740 is configured to receive a fifth command message transmitted by the first account to the AI assistant, the fifth command message being configured for using a first function; and display fifth reply content generated by the AI assistant for the fifth command message, the fifth reply content being a function portal that is of the first function and that is fed back by the AI assistant or a call result obtained after the AI assistant calls the first function.

In some embodiments, the display module 740 is configured to display a function portal of a function of the AI assistant; and display, in response to a trigger operation on the function portal, the recommendation information content recommended by the AI assistant to the first account.

In some embodiments, each of the information cards corresponds to one service function; and the obtaining module 720 is configured to obtain a card template registered by the service function corresponding to the recommendation information content; and fill the card template with the recommendation information content, to obtain the information card corresponding to the recommendation information content.

In some embodiments, the social client includes a program function corresponding to the AI assistant, and the obtaining module 720 is configured to receive, by using the program function corresponding to the AI assistant, a card template registered by each of the at least one service function.

In some embodiments, the social client includes a program function corresponding to the AI assistant, and the obtaining module 720 is configured to receive, by using the program function corresponding to the AI assistant, a performance function supported by the card template registered by the at least one service function, the performance function being configured for executing, when being called, a response function corresponding to the recommendation information content.

FIG. 12 is a structural block diagram of an information content processing apparatus according to an exemplary embodiment of the present disclosure. The apparatus may be a server, or may be arranged in a server. The apparatus includes:

an obtaining module 820, configured to obtain information content of a first account in at least one service function;

a determining module 840, configured to filter or summarize, by using an AI assistant, the information content of the first account in the at least one service function, to obtain recommendation information content recommended by the AI assistant to the first account, the AI assistant being a recommendation service that filters or summarizes information content based on at least an AI model; and

a transmitting module 860, configured to transmit the recommendation information content to a social client in which the first account is located.

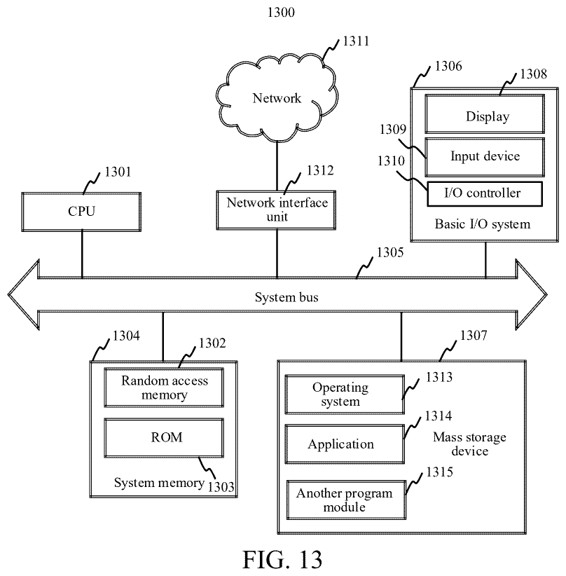

FIG. 13 is a schematic structural diagram of a computer device according to an exemplary embodiment. The computer device may include a terminal device or a server. The computer device 1300 includes a Central Processing Unit (CPU) 1301, a system memory 1304 including a random-access memory (RAM) 1302 and a read-only memory (ROM) 1303, and a system bus 1305 connecting the system memory 1304 to the CPU 1301. In some embodiments, the computer device 1300 may further include a basic input/output (I/O) system 1306 assisting in information transmission between components in the computer device, and a mass storage device 1307 configured to store an operating system 1313, an application 1314, and another program module 1315.

The basic I/O system 1306 includes a display 1308 configured to display information and an input device 1309, such as a mouse or a keyboard, configured to input information for a user. The display 1308 and the input device 1309 are both connected to the CPU 1301 by using an input/output controller 1310 connected to the system bus 1305. The basic I/O system 1306 may further include the input/output controller 1310 to be configured to receive and process inputs from a plurality of other devices such as a keyboard, a mouse, or an electronic stylus. Similarly, the input/output controller 1310 further provides an output to a display screen, a printer, or another type of output device.

The mass storage device 1307 is connected to the CPU 1301 by using a mass storage controller (not shown) connected to the system bus 1305. The mass storage device 1307 and a computer-readable medium associated with the large-capacity storage device provide non-volatile storage for the computer device 1300. In other words, the mass storage device 1307 may include a computer-readable medium (not shown) such as a hard disk or a Compact Disc Read-Only Memory (CD-ROM) drive.

Without losing generality, the computer-readable medium may include a computer-readable storage medium and a communication medium. The computer-readable storage medium includes volatile and non-volatile media, and removable and non-removable media implemented by using any method or technology configured for storing information such as computer-readable instructions, data structures, program modules, or other data. The computer-readable storage medium includes an RAM, an ROM, an Erasable Programmable Read Only Memory (EPROM), an Electrically Erasable Programmable Read-Only Memory (EEPROM), a CD-ROM, a Digital Video Disc (DVD) or another optical memory, a tape cartridge, a magnetic cassette, a magnetic disk memory, or another magnetic storage device. Certainly, those skilled in art may understand that the computer-readable storage medium is not limited to the above several types. The system memory 1304 and the mass storage device 1307 mentioned above may be collectively referred to as a memory.

According to various embodiments of the present disclosure, the computer device 1300 may be further connected, through a network such as the Internet, to a remote computer device on the network for running. That is, the computer device 1300 may be connected to the network 1311 through a network interface unit 1312 connected to the system bus 1305, or may be connected to another type of network or a remote computer device system (not shown) through the network interface unit 1312.

The memory further includes one or more programs. The one or more programs are stored in the memory. The CPU 1301 implements all or part of the operations of the information content processing method by executing the one or more programs.

The present disclosure provides a computer-readable storage medium. The storage medium has at least one program stored therein. The at least one program is loaded and executed by the processor to implement the information content processing method provided in each method embodiment described above.

The present disclosure further provides a computer program product. The computer program product has at least one program stored therein. The at least one program is loaded and executed by the processor to implement the information content processing method provided in each method embodiment described above.

As such, the technical solutions provided in the embodiments of the present disclosure produce at least the following beneficial effects. The recommendation information content recommended by the AI assistant to the user is obtained and displayed after the user account is logged onto, so that the user can quickly obtain important content in a large amount of information on the social client without viewing all original information content, and can master key information in the shortest time, thereby reducing time costs and improving information processing efficiency. In addition, the user does not need to switch interfaces of service functions back and forth, but integrates and displays information in a plurality of dispersed service functions, thereby improving synergy and information density of the service functions, reducing operation costs and information obtaining time, and improving efficiency of using the social client by the user.

The sequence numbers of the foregoing embodiments of the present disclosure are merely for description purpose, and are not intended to indicate priorities of the embodiments.

A person skilled in the art may understand that all or some of the operations of the foregoing embodiments may be implemented by hardware, or may be implemented by a program instructing relevant hardware. The program may be stored in a computer-readable storage medium. The above-mentioned storage medium may be a read-only memory, a magnetic disk, an optical disc, or the like.

The above mentioned descriptions are merely the exemplary embodiments of the present disclosure, but are not intended to limit the present disclosure. Any modification, equivalent replacement, or improvement made without departing from the spirit and principle of the present disclosure need to fall within the protection scope of the present disclosure.

What is claimed is:

1. An information content processing method, performed by a terminal device with a social client logged in with a first account running thereon, the social client comprising at least one service function, and the method comprising:
obtaining recommendation information content recommended by an artificial intelligence (AI) assistant for the first account, the recommendation information content being obtained after the AI assistant filters or summarizes information content of the first account in the at least one service function; and
displaying the recommendation information content.

2. The method according to claim 1, wherein the social client comprises a plurality of service functions, and at least two of the plurality of service functions are located at different human-computer interaction interface levels;
obtaining the recommendation information content recommended by the AI assistant comprises:
obtaining recommendation information content after the AI assistant filters or summarizes the information content of the first account in a first service function, the first service function being located at a first human-computer interaction interface level; and
displaying the recommendation information content comprises:
displaying the recommendation information content at a second human-computer interaction interface level, the second human-computer interaction interface level being higher than the first human-computer interaction interface level.

3. The method according to claim 2, wherein displaying the recommendation information content at the second human-computer interaction interface level comprises:
displaying at least two information cards at the second human-computer interaction interface level, an information card of the at least two information cards being configured for displaying one piece or one group of recommendation information content recommended by the AI assistant for the first account.

4. The method according to claim 3, wherein displaying the at least two information cards at the second human-computer interaction interface level comprises:
displaying the at least two information cards in a tiled manner at the second human-computer interaction interface level, a tiling sequence of the at least two information cards being determined based on recommendation priorities of the at least two information cards; and
the method further comprises:
canceling, in response to a sliding operation on a first information card of the at least two information cards, display of the first information card, and displaying a second information card, the second information card being an information card arranged after the first information card according to the tiling sequence.

5. The method according to claim 3, wherein displaying the at least two information cards at the second human-computer interaction interface level comprises:
displaying the at least two information cards in a stacked manner at the second human-computer interaction interface level, a stacking sequence of the at least two information cards being determined based on recommendation priorities of the at least two information cards; and
the method further comprises:
canceling, in response to a sliding operation on a first information card of the at least two information cards, display of the first information card, and displaying a second information card, the second information card being an information card arranged after the first information card according to the stacking sequence.

6. The method according to claim 1, wherein the recommendation information content comprises at least one of following:
first recommendation information content obtained after unread social messages of the first account are filtered or summarized;
second recommendation information content obtained after group chat messages of the first account or to-do items in a workflow are filtered or summarized;
third recommendation information content obtained after candidate information is filtered or summarized according to a preset rule of the first account;
fourth recommendation information content obtained after friend dynamics information in a social network of the first account is filtered or summarized;
fifth recommendation information content randomly recommended to the first account; or
fifth recommendation information content obtained after information content in which the first account has a potential interest is filtered or summarized;
sixth recommendation information content obtained after information content that has a sharing probability and that is of the first account is filtered or summarized;
seventh recommendation information content obtained after interest groups in which the first account has a potential interest are filtered or summarized;
eighth recommendation information content obtained after point of interest (POI) information corresponding to a current geographic location of the first account is filtered or summarized;
ninth recommendation information content obtained after strange accounts in which the first account has a potential interest are filtered or summarized;
tenth recommendation information content obtained after AI tools in which the first account has a potential interest are filtered or summarized;
eleventh recommendation information content obtained after games in which the first account has a potential interest are filtered or summarized; or
twelfth recommendation information content obtained after related information of third-party applications bound to the first account is filtered or summarized.

7. The method according to claim 1, further comprising:
displaying a shortcut operation portal associated with the recommendation information content; and
executing, in response to an operation on the shortcut operation portal, a shortcut processing function corresponding to the shortcut operation portal.

8. The method according to claim 1, further comprising:
receiving a command message transmitted by the first account to the AI assistant; and
displaying reply content generated by the AI assistant for the command message, the reply content being obtained after the AI assistant filters or summarizes, based on the command message, the information content of the first account in the at least one service function.

9. The method according to claim 8, wherein receiving the command message transmitted by the first account to the AI assistant comprises:
receiving a first command message transmitted by the first account to the AI assistant, the first command message being configured for asking chat content between the first account and a seventh account; and
displaying the reply content generated by the AI assistant for the command message comprises:
displaying first reply content generated by the AI assistant for the first command message, the first reply content being obtained after the AI assistant filters or summarizes the chat content between the first account and the seventh account.

10. The method according to claim 9, wherein receiving the command message transmitted by the first account to the AI assistant comprises:
receiving a second command message transmitted by the first account to the AI assistant, the second command message being configured for asking chat content of a chat group to which the first account belongs; and
displaying the reply content generated by the AI assistant for the command message comprises:
displaying second reply content generated by the AI assistant for the second command message, the second reply content being obtained after the AI assistant filters or summarizes the chat content of the chat group to which the first account belongs.

11. The method according to claim 10, wherein receiving the command message transmitted by the first account to the AI assistant comprises:
receiving a third command message transmitted by the first account to the AI assistant, the third command message being configured for asking attention content of an eighth account as a friend of the first account; and
displaying the reply content generated by the AI assistant for the command message comprises:
displaying third reply content generated by the AI assistant for the third command message, the third reply content being obtained after the AI assistant filters or summarizes friend dynamics information of the eighth account.

12. The method according to claim 11, wherein receiving the command message transmitted by the first account to the AI assistant comprises:
receiving a fourth command message transmitted by the first account to the AI assistant, the fourth command message being configured for asking network information or social chain information associated with a first keyword; and
displaying the reply content generated by the AI assistant for the command message comprises:
displaying fourth reply content generated by the AI assistant for the fourth command message, the fourth reply content being a search result obtained after the AI assistant searches for the network information or the social chain information associated with the first keyword.

13. The method according to claim 12, wherein receiving the command message transmitted by the first account to the AI assistant comprises:
receiving a fifth command message transmitted by the first account to the AI assistant, the fifth command message being configured for using a first function; and
displaying the reply content generated by the AI assistant for the command message comprises:
displaying fifth reply content generated by the AI assistant for the fifth command message, the fifth reply content being a function portal that is of the first function and that is fed back by the AI assistant or a call result obtained after the AI assistant calls the first function.

14. The method according to claim 1, further comprising:
displaying a function portal of a function of the AI assistant; and
obtaining the recommendation information content recommended by the AI assistant for the first account comprises:
displaying, in response to a trigger operation on the function portal, the recommendation information content recommended by the AI assistant to the first account.

15. The method according to claim 3, wherein an information card of the information cards corresponds to one service function; and
the method further comprises:
obtaining a card template registered by the service function corresponding to the recommendation information content; and
filling the card template with the recommendation information content, to obtain the information card corresponding to the recommendation information content.

16. The method according to claim 15, wherein the social client comprises a program function corresponding to the AI assistant, and the method further comprises:
receiving, by using the program function corresponding to the AI assistant, a card template registered by each of the at least one service function.

17. The method according to claim 16, wherein the social client comprises a program function corresponding to the AI assistant, and the method further comprises:
receiving, by using the program function corresponding to the AI assistant, a performance function supported by the card template registered by each of the at least one service function, the performance function being configured for executing, when being called, a response function corresponding to the recommendation information content.

18. The method according to claim 3, further comprising:
obtaining an interest tag of the first account and a weight of the interest tag;
determining recommendation priorities of the at least two information cards based on a target interest tag matching the recommendation information content and a weight of the target interest tag; and
determining a sorting sequence of the at least two information cards based on the recommendation priorities of the at least two information cards.

19. A computer device, having a social client logged in with a first account running thereon, comprising one or more processors and a memory containing at least one program that, when being executed, causes the one or more processors to perform:
obtaining recommendation information content recommended by an artificial intelligence (AI) assistant for the first account, the recommendation information content being obtained after the AI assistant filters or summarizes information content of the first account in at least one service function of the social client; and
displaying the recommendation information content.

20. A non-transitory computer-readable storage medium containing at least one program that, when being executed, causes at least one processor of a computer device that has a social client logged in with a first account running thereon to perform:
obtaining recommendation information content recommended by an artificial intelligence (AI) assistant for the first account, the recommendation information content being obtained after the AI assistant filters or summarizes information content of the first account in at least one service function of the social client; and
displaying the recommendation information content.
